(19) United States
(12) Patent Application Publication
(10) Pub. No.: US 2026/0371310 A1
(43) Pub. Date: Nov. 19, 2026

(54) SYSTEMS AND METHODS OF USER MOTION PREDICTION FOR SATELLITE COMMUNICATIONS

(71) Applicant: Kymeta Corporation, Redmond, WA (US)

(72) Inventors: Navid Tadayon, Ottawa (CA); Paul Klassen, Newcastle, WA (US)

(21) Appl. No.: 19/678,031

(22) Filed: May 14, 2026

Related U.S. Application Data
(60) Provisional application No. 63/807,112, filed on May 16, 2025.

(51) Int. Cl. H04W 64/00; H04B 7/06; H04B 7/185; H04W 84/06

(52) U.S. Cl. CPC H04W 64/006; H04B 7/0617; H04B 7/18519; H04W 84/06

(57) ABSTRACT

Apparatuses and methods for performing user motion prediction for communications (e.g., satellite communications, etc.) are described. In some embodiments, a communication terminal includes a predictive signal processing engine configured to process time-ordered sequences of motion-related sensor data to generate predicted motion characteristics of the antenna and an acquisition and tracking subsystem configured to control at least one beamforming parameter of the antenna based on the predicted motion characteristics, where the acquisition and tracking subsystem adapts the at least one beamforming parameter based on predictions to maintain alignment between the antenna and a remote communication node.

### RELATED APPLICATION

The present application is a non-provisional application of and claims the benefit of U.S. Provisional Patent Application No. 63/807,112, filed May 16, 2025, and entitled “Systems and Methods of User Motion Prediction for Satellite Communications”, which is incorporated by reference in its entirety.

### FIELD OF THE DISCLOSURE

Embodiments disclosed herein are related generally to wireless communication; in particular, embodiments disclosed herein are related to performing motion prediction for use in satellite acquisition and tracking.

### BACKGROUND

Satellite communication systems play a critical role in providing connectivity to mobile and remote platforms, including land vehicles, maritime vessels, and airborne terminals. Modern satellite terminals frequently employ electronically steerable antennas capable of forming and steering one or more communication beams to maintain alignment with a satellite while the terminal platform is in motion. In such systems, acquisition and tracking (A&T) functions are responsible for initially establishing and continuously maintaining beam alignment between the antenna and the satellite in the presence of dynamic platform motion.

Platform motion introduces significant challenges to reliable satellite communication. Mobile terminals experience both intended and unintended motion components. Intended motion may arise from propulsion or maneuvering of a vehicle, vessel, or aircraft, while unintended motion may arise from environmental and structural factors such as road roughness, engine vibration, turbulence, waves, wind, shock, mechanical imbalance, or structural resonance. These motion components manifest as translation and rotation of the antenna platform, often occurring simultaneously and with varying frequency and amplitude content.

Even relatively small angular deviations in antenna orientation can result in substantial pointing error, leading to degradation in antenna gain, signal-to-noise-plus-interference ratio (SINR), and overall throughput. In electronically steerable antenna systems, this degradation can occur quickly when the dynamics of platform motion exceed the responsiveness of beam steering and tracking algorithms. As a result, maintaining reliable communication links on mobile platforms remains a technically demanding problem.

Conventional approaches to acquisition and tracking typically rely on reactive or feedback-based techniques. In such approaches, antenna control parameters are adjusted based on observed signal quality metrics, such as received signal strength, error rates, or tracking error measurements. While adaptation may improve performance compared to static configurations, these approaches inherently respond only after performance degradation has already begun. In highly dynamic environments, this reactive behavior may be insufficient to prevent link degradation or outages.

One approach to improving tracking robustness involves the use of increasingly precise and expensive sensors to directly measure platform motion, such as tactical-grade inertial measurement units, multi-sensor fusion systems, or auxiliary sensing modalities. While such sensors may provide accurate measurements, they increase system cost, size, weight, power consumption, and complexity. In many mobile communication applications, particularly those involving mass-produced terminals, cost and complexity constraints limit the feasibility of relying solely on high-precision sensing hardware.

### SUMMARY

Apparatuses and methods for performing user motion prediction for communications (e.g., satellite communications, etc.) are described. In some embodiments, a communication terminal includes an antenna to form and steer one or more communication beams; one or more sensors configured to generate motion-related sensor data associated with motion of the antenna; and a predictive signal processing engine. The predictive signal processing engine is configured to process time-ordered sequences of the motion-related sensor data to generate predicted motion characteristics of the antenna. The communication terminal also includes an acquisition and tracking subsystem coupled to the predictive signal processing engine and configured to control at least one beamforming parameter of the antenna based on the predicted motion characteristics, wherein the acquisition and tracking subsystem adapts the at least one beamforming parameter based on predictions to maintain alignment between the antenna and a remote communication node.

In some other embodiments, a method includes receiving time-sequenced motion data, including sampling inertial sensors including an accelerometer and a gyroscope over a time period; generating a prediction of at least one motion characteristic, including classifying the time-sequenced motion data into one of a plurality of motion scenarios; determining at least one control adjustment for acquisition and tracking based on the one motion scenario into which the time-sequenced motion data is classified; and controlling acquisition and tracking by adjusting at least one beamforming parameter to modify beam steering.

In yet some other embodiments, a satellite terminal includes an antenna; an acquisition and tracking (A&T) subsystem coupled to the antenna to establish and maintain communications with one or more satellites based on motion profile information corresponding to motion of the antenna; and a predictive signal processing engine to predict characteristics of motion profile of one or more satellite communication antennas using sequence of input sensory measurements including but not limited to inertial sensory measurements. The predictive signal processing engine uses a generative model to synthesize motion data in a plurality of stages, where the plurality of stages comprises: a first stage to train an unsupervised model using limited real data to train an unsupervised model to learn a feature space, and a second stage operable to use a decoder part of the unsupervised model to synthetically generate sensory data that executes motion.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The embodiments described herein and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates an exploded isometric view of a satellite antenna according to some embodiments.

FIG. 2 illustrates a schematic view of a satellite communication system according to some embodiments.

FIG. 3 illustrates some embodiments of a parameter selector that is responsive to a motion prediction from a predictive model.

FIG. 4 illustrates an example of motion sensor data collected under different operating conditions.

FIG. 5 illustrates how learning-based models can disentangle underlying factors of variation in motion data, enabling identification or inference of motion profiles that are not explicitly discernible from raw inertial measurements.

FIG. 6 illustrates an example operational data flow in which predicted motion characteristics are used to adapt acquisition and tracking behavior of a communication terminal.

FIG. 7 is a flow diagram of some embodiments of a process for controlling an acquisition and tracking system using a predictive model.

FIG. 8 illustrates an example of supervised learning applied to motion profile prediction using inertial sensor data.

FIG. 9 illustrates examples of platforms used to collect motion data for training and evaluation of predictive models.

FIG. 10 illustrates an example of regression based predictive architecture for inferring continuous motion characteristics from inertial sensor data.

FIG. 11 illustrates an example of such a process for generating labeled motion data for training regression models.

FIG. 12 illustrates an example of such a process for generating labeled motion data for training regression models.

FIG. 13 illustrates an example of supervised stage-II training.

FIG. 14 illustrates an example transformation of inertial sensor data into the spectral domain

FIG. 15 illustrates an example of a few shot learning architecture for motion profile prediction.

FIG. 16 illustrates this problem for 1D input data where inertial sensor data does not uniquely correspond to a single motion profile.

FIG. 17 illustrates an architecture in which a motion-profile learning is applied to a probabilistic supervised model with the conditional distribution is forced to be a mixture of Gaussians

FIG. 18 illustrates an unsupervised learning approach in which masked or incomplete spectral representations of motion data are provided to a trained model.

FIG. 19 illustrates such an unsupervised inference approach for resolving latent motion components from spectral representations of inertial sensor data.

FIG. 20 illustrates an example embodiment for synthesizing motion sensor data using a learning based generative model.

### DETAILED DESCRIPTION

In the following description, numerous details are set forth to provide a more thorough explanation of embodiments of the present disclosure. It will be apparent, however, to one skilled in the art, that the teachings disclosed herein may be practiced without these specific details. In other instances, well-known structures and devices are shown in block diagram form, rather than in detail, to avoid obscuring the present disclosure.

Embodiments disclosed herein include the systems and methods of designing and using a predictive signal processing engine to enable a proactive approach to A&T. Such embodiments leverage time-ordered sensor data to infer motion characteristics, particularly when the time-ordered sensor data includes long sequences of inertial sensor data that contain latent information about underlying motion characteristics, including vibration statistics, rotational dynamics, and environmental influences, even when individual measurements appear noisy or ambiguous. The systems and methods use those inferences to guide acquisition and tracking behavior in a proactive and adaptive manner. These systems and methods can be used for acquisition and tracking in mobile communication terminals to proactively adapt antenna control behavior based on anticipated or inferred motion conditions. In some embodiments, such systems operate using cost-effective sensing hardware, to integrate with existing pointing and tracking architectures, and to accommodate uncertainty and variability in platform motion without requiring fundamental changes to established antenna control algorithms. The disclosed techniques may improve robustness, reduce pointing error, and enhance quality of service across a wide range of operating conditions, while remaining compatible with practical system constraints of mobile satellite communication terminals.

### Examples of Antenna Embodiments

The techniques described herein may be used with a variety of flat panel satellite antennas. Some embodiments of such flat panel antennas are disclosed herein. In some embodiments, the flat panel satellite antennas are part of a satellite terminal. The flat panel antennas include one or more arrays of antenna elements on an antenna aperture.

In some embodiments, the antenna aperture is a metasurface antenna aperture, such as, for example, the antenna apertures described below. In some embodiments, the antenna elements comprise radio-frequency (RF) radiating antenna elements. In some embodiments, the antenna elements include tunable devices to tune the antenna elements. Examples of such tunable devices include diodes and varactors such as, for example, described in U.S. Pat. No. 11,489,266, entitled “Metasurface Antennas Manufactured with Mass Transfer Technologies,” issued Nov. 1, 2022. In some other embodiments, the antenna elements comprise liquid crystal (LC)-based antenna elements, such as, for example, those disclosed in U.S. Pat. No. 9,887,456, entitled “Dynamic Polarization and Coupling Control from a Steerable Cylindrically Fed Holographic Antenna”, issued Feb. 6, 2018, or other RF radiating antenna elements. It should be appreciated that other tunable devices such as, for example, but not limited to, tunable capacitors, tunable capacitance dies, packaged dies, micro-electromechanical systems (MEMS) devices, or other tunable capacitance devices, could be placed into an antenna aperture or elsewhere in variations on the embodiments described herein.

Although embodiments in this disclosure may draw on some examples in communications, some embodiments could be implemented in various receiving, transmitting, and/or sensing or other similar applications. Some examples could include devices for radar, lidar, sensors and sensing device such as, but not limited to, those in autonomous vehicles applications, and any other applications that can take advantage of attributes of an active metasurface according to various disclosed and undisclosed embodiments of the present disclosure.

In some embodiments, the antenna aperture having the one or more arrays of antenna elements is comprised of multiple segments that are coupled together. In some embodiments, when coupled together, the combination of the segments form groups of antenna elements (e.g., closed rings of antenna elements concentric with respect to the antenna feed, etc.). For more information on antenna segments, see U.S. Pat. No. 9,887,455, entitled “Aperture Segmentation of a Cylindrical Feed Antenna”, issued Feb. 6, 2018.

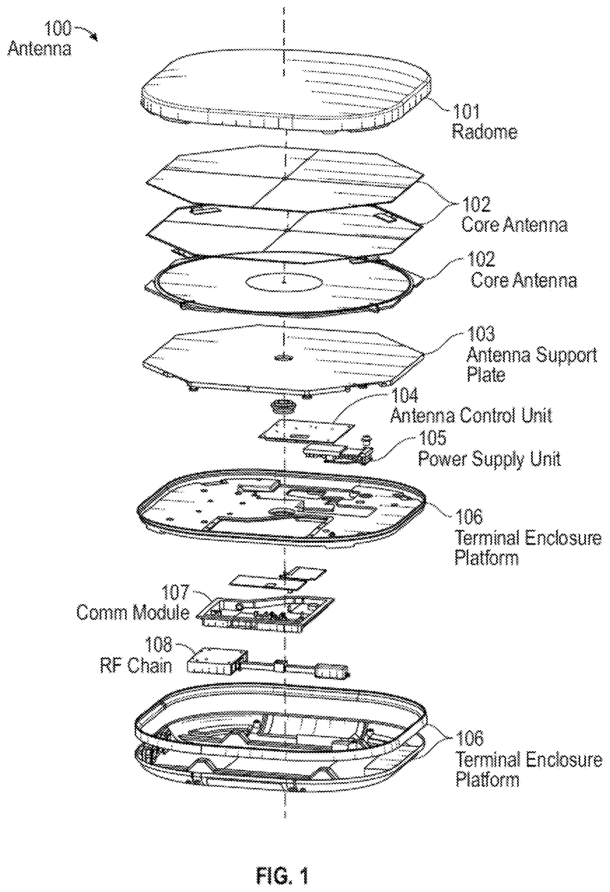

FIG. 1 illustrates an exploded view of some embodiments of a flat-panel antenna. Referring to FIG. 1, antenna 100 comprises a radome 101, a core antenna 102, antenna support plate 103, antenna control unit (ACU) 104, a power supply unit 105, terminal enclosure platform 106, comm (communication) module 107, and RF chain 108.

Radome 101 is the top portion of an enclosure that encloses core antenna 102. In some embodiments, radome 101 is weatherproof and is constructed of material transparent to radio waves to enable beams generated by core antenna 102 to extend to the exterior of radome 101.

In some embodiments, core antenna 102 comprises an aperture having RF radiating antenna elements. These antenna elements act as radiators (or slot radiators). In some embodiments, the antenna elements comprise scattering metamaterial antenna elements. In some embodiments, the antenna elements comprise both Receive (Rx) and Transmit (Tx) irises, or slots, that are interleaved and distributed on the whole surface of the antenna aperture of core antenna 102. Such Rx and Tx irises may be in groups of two or more sets where each set is for a separately and simultaneously controlled band. Examples of such antenna elements with irises are described in U.S. Pat. No. 10,892,553, entitled “Broad Tunable Bandwidth Radial Line Slot Antenna”, issued Jan. 12, 2021.

In some embodiments, the antenna elements comprise irises (iris openings) and the aperture antenna is used to generate a main beam shaped by using excitation from a cylindrical feed wave for radiating the iris openings through tunable elements (e.g., diodes, varactors, patch, etc.). In some embodiments, the antenna elements can be excited to radiate a horizontally or vertically polarized electric field at desired scan angles.

In some embodiments, a tunable element (e.g., diode, varactor, patch etc.) is located over each iris slot. The amount of radiated power from each antenna element is controlled by applying a voltage to the tunable element using a controller in ACU 104. Traces in core antenna 102 to each tunable element are used to provide the voltage to the tunable element. The voltage tunes or detunes the capacitance and thus the resonance frequency of individual elements to effectuate beam forming. The voltage required is dependent on the tunable element in use. Using this property, in some embodiments, the tunable element (e.g., diode, varactor, LC, etc.) integrates an on/off switch for the transmission of energy from a feed wave to the antenna element. When switched on, an antenna element emits an electromagnetic wave like an electrically small dipole antenna. Note that the teachings herein are not limited to having unit cell that operates in a binary fashion with respect to energy transmission. For example, in some embodiments in which varactors are the tunable element, there are 32 tuning levels. As another example, in some embodiments in which LC is the tunable element, there are 16 tuning levels.

A voltage between the tunable element and the slot can be modulated to tune the antenna element (e.g., the tunable resonator/slot). Adjusting the voltage varies the capacitance of a slot (e.g., the tunable resonator/slot). Accordingly, the reactance of a slot (e.g., the tunable resonator/slot) can be varied by changing the capacitance. Resonant frequency of the slot also changes according to the equation

$$f = \frac{1}{2 π \sqrt{LC}}$$

where f is the resonant frequency of the slot and L and C are the inductance and capacitance of the slot, respectively. The resonant frequency of the slot affects the energy coupled from a feed wave propagating through the waveguide to the antenna elements.

In particular, the generation of a focused beam by the metamaterial array of antenna elements can be explained by the phenomenon of constructive and destructive interference, which is well known in the art. Individual electromagnetic waves sum up (constructive interference) if they have the same phase when they meet in free space to create a beam, and waves cancel each other (destructive interference) if they are in opposite phase when they meet in free space. If the slots in core antenna 102 are positioned so that each successive slot is positioned at a different distance from the excitation point of the feed wave, the scattered wave from that antenna element will have a different phase than the scattered wave of the previous slot. In some embodiments, if the slots are spaced one quarter of a wavelength apart, each slot will scatter a wave with a one fourth phase delay from the previous slot. In some embodiments, by controlling which antenna elements are turned on or off (i.e., by changing the pattern of which antenna elements are turned on and which antenna elements are turned off) or which of the multiple tuning levels is used, a different pattern of constructive and destructive interference can be produced, and the antenna can change the direction of its beam(s).

In some embodiments, core antenna 102 includes a coaxial feed that is used to provide a cylindrical wave feed via an input feed, such as, for example, described in U.S. Pat. No. 9,887,456, entitled “Dynamic Polarization and Coupling Control from a Steerable Cylindrically Fed Holographic Antenna”, issued Feb. 6, 2018 or in U.S. Pat. No. 11,489,266, entitled “Metasurface Antennas Manufactured with Mass Transfer Technologies,” issued Nov. 1, 2022. In some embodiments, the cylindrical wave feed feeds core antenna 102 from a central point with an excitation that spreads outward in a cylindrical manner from the feed point. In other words, the cylindrically fed wave is an outward travelling concentric feed wave. Even so, the shape of the cylindrical feed antenna around the cylindrical feed can be circular, square or any shape. In some other embodiments, a cylindrically fed antenna aperture creates an inward travelling feed wave. In such a case, the feed wave most naturally comes from a circular structure.

In some embodiments, the core antenna comprises multiple layers. These layers include the one or more substrate layers forming the RF radiating antenna elements. In some embodiments, these layers may also include impedance matching layers (e.g., a wide-angle impedance matching (WAIM) layer, etc.), one or more spacer layers and/or dielectric layers. Such layers are well-known in the art.

Antenna support plate 103 is coupled to core antenna 102 to provide support for core antenna 102. In some embodiments, antenna support plate 103 includes one or more waveguides and one or more antenna feeds to provide one or more feed waves to core antenna 102 for use by antenna elements of core antenna 102 to generate one or more beams.

ACU 104 is coupled to antenna support plate 103 and provides controls for antenna 100. In some embodiments, these controls include controls for drive electronics for antenna 100 and a matrix drive circuitry to control a switching array interspersed throughout the array of RF radiating antenna elements. In some embodiments, the matrix drive circuitry uses unique addresses to apply voltages onto the tunable elements of the antenna elements to drive each antenna element separately from the other antenna elements. In some embodiments, the drive electronics for ACU 104 comprise commercial off-the shelf LCD controls used in commercial television appliances that adjust the voltage for each antenna element.

More specifically, in some embodiments, ACU 104 supplies an array of voltage signals to the tunable devices of the antenna elements to create a modulation, or control, pattern. The control pattern causes the elements to be tuned to different states. In some embodiments, ACU 104 uses the control pattern to control which antenna elements are turned on or off (or which of the tuning levels is used) and at which phase and amplitude level at the frequency of operation. The elements are selectively detuned for frequency operation by voltage application. In some embodiments, multistate control is used in which various elements are turned on and off to varying levels, further approximating a sinusoidal control pattern, as opposed to a square wave (i.e., a sinusoid gray shade modulation pattern).

In some embodiments, ACU 104 also contains one or more processors executing the software to perform some of the control operations. ACU 104 may control one or more sensors (e.g., a GPS receiver, a three-axis compass, a 3-axis accelerometer, 3-axis gyro, 3-axis magnetometer, etc.) to provide location and orientation information to the processor(s). The location and orientation information may be provided to the processor(s) by other systems in the earth station and/or may not be part of the antenna system.

Antenna 100 also includes a comm (communication) module 107 and an RF chain 108. Comm module 107 includes one or more modems enabling antenna 100 to communicate with various satellites and/or cellular systems, in addition to a router that selects the appropriate network route based on metrics (e.g., quality of service (QoS) metrics, e.g., signal strength, latency, etc.). RF chain 108 converts analog RF signals to digital form. In some embodiments, RF chain 108 comprises electronic components that may include amplifiers, filters, mixers, attenuators, and detectors.

Antenna 100 also includes power supply unit 105 to provide power to various subsystems or parts of antenna 100.

Antenna 100 also includes terminal enclosure platform 106 that forms the enclosure for the bottom of antenna 100. In some embodiments, terminal enclosure platform 106 comprises multiple parts that are coupled to other parts of antenna 100, including radome 101, to enclose core antenna 102.

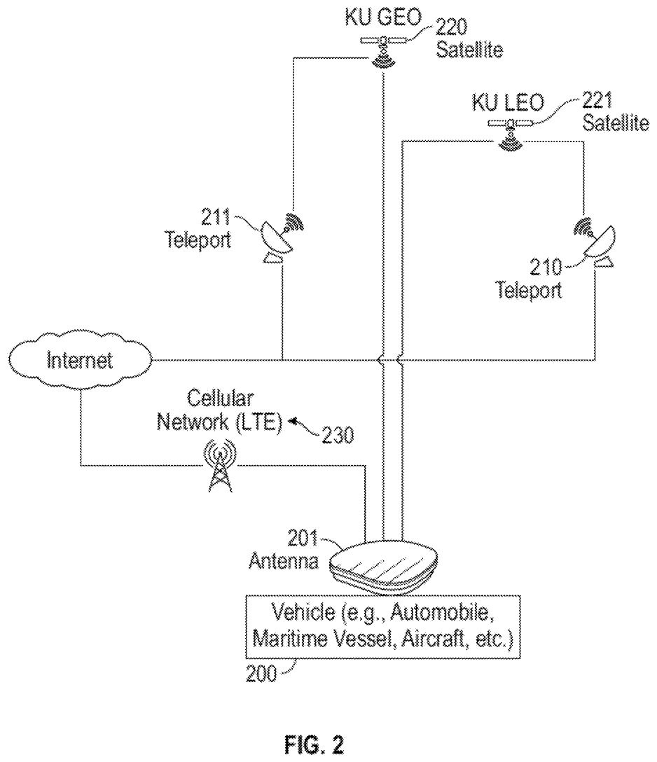

FIG. 2 illustrates an example of a communication system that includes one or more antennas described herein. Referring to FIG. 2, vehicle 200 includes an antenna 201. In some embodiments, antenna 201 comprises antenna 100 of FIG. 1. In some embodiments, vehicle 200 may comprise any one of several vehicles, such as, for example, but not limited to, an automobile (e.g., car, truck, bus, etc.), a maritime vehicle (e.g., boat, ship, etc.), airplanes (e.g., passenger jets, military jets, small craft planes, etc.), etc. Antenna 201 may be used to communicate while vehicle 200 is either on-the-pause or moving. Antenna 201 may be used to communicate to fixed locations as well, e.g., remote industrial sites (mining, oil, and gas) and/or remote renewable energy sites (solar farms, windfarms, etc.).

In some embodiments, antenna 201 is able to communicate with one or more communication infrastructures (e.g., satellite, cellular, networks (e.g., the Internet), etc.). For example, in some embodiments, antenna 201 is able to communication with satellites 220 (e.g., a GEO satellite) and 221 (e.g., a LEO satellite), cellular network 230 (e.g., an LTE, etc.), as well as network infrastructures (e.g., edge routers, Internet, etc.). For example, in some embodiments, antenna 201 comprises one or more satellite modems (e.g., a GEO modem, a LEO modem, etc.) to enable communication with various satellites such as satellite 220 (e.g., a GEO satellite) and satellite 221 (e.g., a LEO satellite) and one or more cellular modems to communicate with cellular network 230. For another example of an antenna communicating with one or more communication infrastructures, see U.S. Pat. No. 11,818,606, entitled “Multiple Aspects of Communication in a Diverse Communication Network”, and issued Nov. 14, 2023. Communication between a network, such as for example, the Internet and satellites 220 and 221 can be via teleports 211 and 210, respectively.

In some embodiments, to facilitate communication with various satellites, antenna 201 performs dynamic beam steering. In such a case, antenna 201 is able to dynamically change the direction of a beam that it generates to facilitate communication with different satellites. In some embodiments, antenna 201 includes multi-beam beam steering that allows antenna 201 to generate two or more beams at the same time, thereby enabling antenna 201 to communication with more than one satellite at the same time. Such functionality is often used when switching between satellites (e.g., performing a handover). For example, in some embodiments, antenna 201 generates and uses a first beam for communicating with satellite 220 and generates a second beam simultaneously to establish communication with satellite 221. After establishing communication with satellite 221, antenna 201 stops generating the first beam to end communication with satellite 220 while switching over to communicate with satellite 221 using the second beam. For more information on multi-beam communication, see U.S. Pat. No. 11,063,661, entitled “Beam Splitting Hand Off Systems Architecture”, issued Jul. 13, 2021.

In some embodiments, antenna 201 uses path diversity to enable a communication session that is occurring with one communication path (e.g., satellite, cellular, etc.) to continue during and after a handover with another communication path (e.g., a different satellite, a different cellular system, etc.). For example, if antenna 201 is in communication with satellite 220 and switches to satellite 221 by dynamically changing its beam direction, its session with satellite 220 is combined with the session occurring with satellite 221.

Thus, the antennas described herein may be part of a satellite terminal that enables ubiquitous communications and multiple different communication connections. In some embodiments, antenna 201 comprises a metasurface RF antenna having multiple RF radiating antenna elements that are tuned to desired frequencies using RF antenna element drive circuitry. The drive circuitry can include a drive transistor (e.g., a thin film transistor (TFT) (e.g., CMOS, NMOS, etc.), low or high temperature polysilicon transistor, memristor, etc.), a Microelectromechanical systems (MEMS) circuit, or other circuit for driving a voltage to an RF radiating antenna element. In some embodiments, the drive circuitry comprises an active-matrix drive. In some embodiments, the frequency of each antenna element is controlled by an applied voltage. In some embodiments, this applied voltage is also stored in each antenna element (pixel circuit) until the next voltage writing cycle.

### Systems and Methods of User Motion Prediction for Satellite Communications

Embodiments disclosed herein include performing acquisition and tracking (A&T) using a proactive approach where the antenna functionalities are cognitively adapted based on reliable predictions made by a predictive signal processing engine. Embodiments disclosed herein include the systems and methods of designing the above-mentioned predictive signal processing engine to enable such a proactive approach.

Embodiments disclosed herein include systems and methods for utilizing learning techniques on long sequences of inertial sensory measurements (as a minimum set of sensors) to gain distinctive clues about the characteristics of the motion to improve the robustness and precision of A&T-related tasks. For purposes herein, “long sequences” of inertial sensory measurements refer to time-ordered sensor data collected over intervals sufficient to capture meaningful motion characteristics. In some embodiments, such sequences span durations on the order of seconds to minutes, with inertial measurements sampled at rates of tens to hundreds of samples per second or higher. To achieve this goal, architectures comprising unsupervised and supervised learning are disclosed.

In some embodiments, for supervised learning, the predictive signal processing engine predicts characteristics of motion profiles of satellite communication antennas using a sequence of input sensory measurements including but not limited to inertial sensory measurements. In some embodiments, the predictive signal processing engine is a classifier model. In some embodiments, the predictive signal processing engine is a regression model. In some embodiments, for the regression model, desired compositional motion is synthesized using superposition of several constituent motions and captured through inertial sensors onboard the antenna. Such an antenna can be mounted on a robot. These input traces are then annotated with output data that is the individual motion components themselves. This data is then used to train a supervised learning regression model.

In some embodiments, a proper data embedding of traces of input motion (e.g., kinematic) data is first found through unsupervised learning which is followed by supervised learning using these low-dimensional motion embeddings and labels. In some embodiments, auto-encoders are used in unsupervised pre-training stage to reduce dimensionality of the problem. In some embodiments, the input data shown to the learning algorithm entails a transformation of the raw sensory measurements including, but not limited to, multi-dimensional spectral decomposition of the sensory data.

In some embodiments, the predictive signal processing engine is built using few-shot learning where raw inertial/motion data is initially clustered in the label domain rather than classifying it, where labels are generated/guessed through a tandem clustering algorithm, for example, followed by training with supervised backpropagation. In such a case, the learning algorithm uses those labels to train the preceding neural network. Once training is finished, a second stage of training is then followed using a few labelled samples to color the clusters with semantical labels. In some embodiments, the clustering algorithm can be as simple as K-means or as advanced as hierarchical or spectral clustering. In some other embodiments, instead of tandem clustering, a compound loss function that constitutes a quadratic loss as well as a clustering loss is utilized.

In some embodiments, the predictive model uses a loss function that is not deterministic but probabilistic to address the situation where the input data is not uniquely descriptive of the output labels. In some embodiments, the predictive signal processing engine uses a probabilistic supervised model that is based on a mixture conditional distribution, where the output of the model is not deterministic motion labels but the parameters of a mixture distribution.

In some embodiments, the predictive signal processing engine uses supervised learning of motion profiles where inferences made on a pretrained data-driven model are utilized to adapt the hyper-parameters of several model-based A&T functions. In some embodiments, the predicted motion characteristics generated by the predictive signal processing engine are used to select or adjust one or more acquisition and tracking parameters of an existing pointing and tracking algorithm. For example, the predictive signal processing engine may output a motion profile classification (e.g., land-mobile scenario A versus land-mobile scenario B) or a statistical representation of motion conditions, and the acquisition and tracking subsystem may select a corresponding set of parameter values associated with that output.

In some such embodiments, the selected parameters include one or more of a dithering stride, a half-power beamwidth of the antenna, a beam dwell time, or combinations thereof. For instance, a motion profile associated with relatively low vibration may be mapped to a first parameter set having a narrower beamwidth and smaller dithering stride, whereas a motion profile associated with higher vibration may be mapped to a second parameter set having a wider beamwidth and larger dithering stride.

The functional relationship between predicted motion characteristics and acquisition and tracking parameter selection may be implemented using lookup tables, rule-based logic, learned correlations, or combinations thereof, and need not require modification of the underlying pointing and tracking algorithm itself.

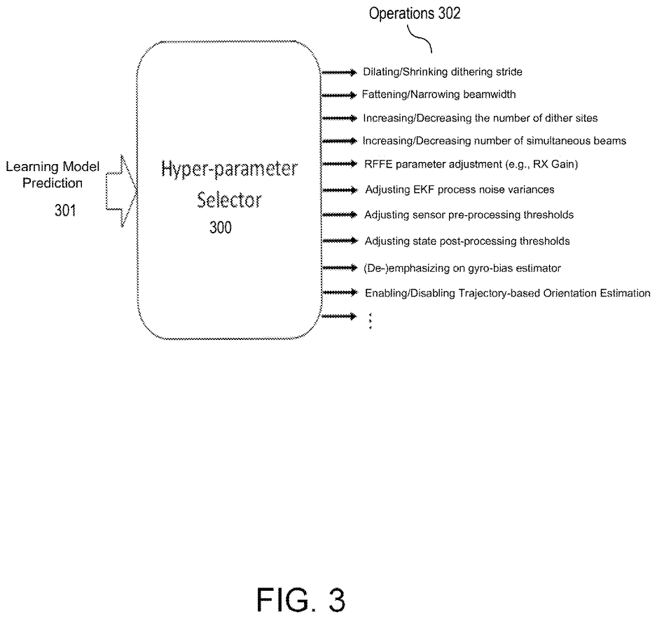

In some embodiments, techniques disclosed herein adaptively select the values of parameters for different functionalities are implemented. FIG. 3 illustrates a learning model prediction being input into a hyper-parameter selector to control the output of the hyper-parameter selector. Referring to FIG. 3, a hyper-parameter selector 300 receives a learning model prediction 301. Based on the learning model prediction 301, hyper-parameter selector 300 selects one or more A&T parameters and outputs one or more control operations. Examples of operations include, but are not limited to, dilating/shrinking dithering slide, fattening/narrowing beamwidth, increasing/decreasing the number of dither sites, increasing/decreasing the number of simultaneous beams, adjusting one or more RF front-end parameters (e.g., receive (Rx) gain, etc.), adjusting Extended Kalman Filter (EKF) process noise variances, adjusting sensor pre-processing thresholds, adjusting state post-processing thresholds, (de-)emphasizing on gyro-bias estimator, enabling/disabling trajectory-based orientation estimation.

In some embodiments, the model outputs a model prediction 301 that specifies a discrete motion class. The following examples illustrate non-limiting mappings between predicted motion characteristics and acquisition and tracking adaptations implemented by the hyper-parameter selector.

Table 1 below sets forth examples of model predictions and their meaning in accordance with some embodiments.

TABLE 1

| Model prediction | Meaning |
|---|---|
| Stationary | Terminal is not moving or moving very |
| | little |
| Low-dynamic | Slow vehicle motion, smooth platform |
| motion | motion |
| High-dynamic | Fast turns, vibration, acceleration, rough |
| motion | terrain |
| Periodic/vibratory | Motion dominated by vibration, engine |
| motion | rumble, road bumps |
| Sudden maneuver | Rapid yaw/pitch/roll transient |
| Degraded sensor | IMU data inconsistent, saturated, or |
| confidence | noisy |

In such a case, the hyper-parameter selector 300 performs a T&A adaptation. Examples of such adaptations in response to the predicted motion class in accordance with some embodiments are given in Table 2 below.

TABLE 2

| Predicted motion | |
|---|---|
| class | Tracking/acquisition adaptation |
| Stationary | Use narrow search window, low loop bandwidth, |
| | reduced update rate |
| Low-dynamic | Moderate search window, nominal tracking gain |
| High-dynamic | Wider search window, higher loop bandwidth, |
| | faster re-acquisition |
| Periodic vibration | Increase smoothing or use notch/vibration-aware |
| | filtering |
| Sudden maneuver | Temporarily expand beam search region or |
| | increase dither amplitude |
| Low confidence | Fall back to conservative tracking parameters |

In some embodiments, model prediction 301 outputs a prediction of estimated angular motion quantities. Table 3 below sets forth examples of model predictions and the control operation 302 that is made in accordance with some embodiments. For example, in some embodiments, if the learning prediction model (e.g., a neural network) predicts that the terminal has high yaw-rate variance, then hyper-parameter selector 300 increases the azimuth tracking bandwidth or expands the azimuth acquisition window.

TABLE 3

| Model output | Example use |
|---|---|
| Stationary | Use narrow search window, low loop |
| | bandwidth, reduced update rate |
| Predicted angular | Set tracking loop bandwidth |
| rate RMS | |
| Predicted angular | Set beam search expansion rate |
| acceleration RMS | |
| Predicted yaw/pitch/ | Set allowable beam pointing prediction |
| roll rate envelope | bounds |
| Predicted vibration | Tune filters or averaging windows |
| frequency | |
| Predicted maneuver | Trigger re-acquisition or wider tracking |
| probability | mode |

In some embodiments, hyper-parameter selector 300 adapts dither and/or probing parameters. For example, in some embodiments, for a dither-based tracking algorithm, the model prediction controls the tracking algorithm as set forth in Table 4.

TABLE 4

| Parameter | How motion prediction affects it |
|---|---|
| Dither radius/stride | Larger during high-dynamic motion, |
| | smaller during stationary motion |
| Dither dwell time | Shorter during fast motion, longer during |
| | stable motion |
| Number of dither | More points when uncertainty is high |
| points | |
| Dither update rate | Faster when motion dynamics are high |
| Averaging time | Reduced during fast motion to avoid stale |
| per point | measurements |

In some embodiments, the predictive model outputs a probability of beam loss or tracking degradation. In response to the input, the hyper-parameter selector 300 adjusts acquisition thresholds, reacquisition trigger thresholds, or satellite handoff timing based on the predicted probability. In some embodiments, the model can also predict loss-of-lock risk. Examples of adjustments to the T&A algorithm based on the model prediction of loss-of-lock are given below in Table 5.

TABLE 5

| Model prediction | Algorithm adjustment |
|---|---|
| Low risk of loss | Maintain normal tracking |
| Medium risk | Increase monitoring rate |
| High risk | Preemptively expand search area |
| Imminent loss | Start parallel acquisition or beam reacquisition |
| Stable again | Return to narrow tracking mode |

The model may also affect the sensor fusion side. In some embodiments, the predictive model outputs adaptations for sensor fusion based on the model prediction. These can include adapting IMU/sensor weighting. For instance, in some embodiments, the model prediction is received by the hyper-parameter selector 300 and used to adjust process-noise parameters, measurement-noise parameters, or sensor weighting factors in an estimator that predicts the antenna pointing direction.

TABLE 6

| Model prediction | Sensor fusion adaptation |
|---|---|
| Smooth motion | Trust inertial propagation more |
| High vibration | Reduce IMU weight or increase IMU noise |
| | covariance |
| Sensor saturation | Ignore or de-weight affected sensor channels |
| High rotational | Increase process noise in attitude prediction |
| dynamics | |
| Low dynamics | Reduce process noise |

In some embodiments, the predictive signal processing engine is built using unsupervised learning of the motion profile of the satellite communication antenna. In some embodiments, the unsupervised learning includes learning motion clues from unlabeled traces of sensory inertial data collected by inertial sensor inside the antennas. In some embodiments, the predictive signal processing engine includes an autoencoder that is trained on some form of transformation of sequential input sensory motion data. In some embodiments, the training of the autoencoder uses spectral decomposition such as Fourier Transform (FT). In some other embodiments, during an inference step, different parts of the spectrum (for instance by filtering) of data are masked and shown to the trained model to enforce unsupervised deep model to reconstruct the manipulated data based on the learned features.

In some embodiments, the predictive signal processing engine uses a generative model to synthesize motion data in two stages. In the first stage, limited real data is used to train an unsupervised model to learn the feature space, and the second stage uses a decoder part of the unsupervised model to synthesize realistically looking sensory data. This data is then used to execute motion on a robot.

With learning-based inference algorithms running in the backend of A&T algorithms, more robustness and higher precision on different A&T tasks can be achieved. The robustness and higher precision result in improved quality of service that may not be achieved using non-predictive techniques. Another advantage to this predictive-based technique is related to cost-saving achieved by using inexpensive sensors and learning-based inference algorithms instead of using expensive and highly accurate sensors. The latter is indeed the mainstream approach to achieve better performance even though the cost can be prohibitive at times.

Embodiments of the predictive signal processing engine disclosed herein use one or more supervised and unsupervised learning algorithms for the training of their models. In some embodiments, training and deployment of the predictive signal processing engine are performed in multiple stages. A first training stage may comprise pretraining the predictive model offline using motion data collected across one or more known motion scenarios, including data captured in controlled test environments or from field datasets compiled over time.

A second stage may comprise deploying the pretrained model on the communication terminal to perform real-time inference using motion sensor data generated during operation of the terminal. In addition, in some embodiments, the predictive model undergoes incremental refinement or fine-tuning while deployed in the field. Such refinement may be performed using unsupervised or self-supervised learning techniques and may occur concurrently with inference, without requiring removal of the antenna or interruption of communication service.

The infield refinement may adapt model parameters to motion characteristics specific to an individual terminal or deployment environment, thereby improving robustness across differing operating conditions.

In some embodiments, motion prediction and corresponding acquisition and tracking adjustments are performed on a periodic or nonrealtime basis. The predictive signal processing engine may execute inference using motion sensor data at intervals selected according to computational and power constraints of the communication terminal and the dynamics of the operating environment.

By way of example and not limitation, inference may be performed every one to several seconds, such that predictions are updated frequently enough to respond to changes in motion while avoiding excessive processing overhead. In other embodiments, inference may be event-driven, such as in response to detection of a change in motion statistics exceeding a threshold.

The task of acquisition and tracking (A&T) is a crucial component in satellite communications where electromagnetic beams are focused, and the endpoints are mobile. On the terminal side, the components of the platform motion may include both translation and rotation, which are affected by intended forces but also unintended ones. The intended force is the thrust of the land mobile platform, the propelling of the maritime platform, or the propulsion force of jet engine in an aerial platform. The unintended force is caused by environmental effects as well as structural problems and includes varying causes such as drag, engine vibration, waves, shock, road roughness/bumpiness, turbulence, weight/tire imbalance, weight shift in vessels, and so on. The aggregate effect of the intended and unintended motion on communications is a beam that does not perfectly align with the energy-maximizing direction of the satellite at all times. This motion-related pointing error causes drops in gain which, subsequently, degrades the signal-to-noise-plus-interface ratio (SINR) as well as the throughput for all users in the network.

Two approaches to deal with such uncertainties include adaptive and nonadaptive approaches. For instance, a flat-panel terminal mounted on a vehicle that has imbalanced tires, or a deformed axle will inherit the vibration that emerges when the vehicle speed exceeds a certain threshold. This vibration, subsequently, affects the beam-pointing stability. If the frequencies and amplitudes of the vibrations are such that the beam agility cannot keep up, mis-pointing may occur, and throughput degradation is experienced. For example, if the vibration causes oscillation of only 0.5 degree around the pitch/roll axis of a car, the communication throughput drops by almost 50%. Adjusting the beamwidth and/or beam stride of the tracking engine according to the level of vibration experienced adapts the system to this stress. However, this adjustment requires knowing the statistics of vibration; otherwise, any action taken will be random.

Techniques disclosed herein show how to infer statistics of environmental effects, such as, for example but not limited to, vibration, propulsive motion of other nearby (possibly larger) platforms, and the effect of wind and waves on deviation from a neutral orientation (such as a maritime vessel in a turbulent sea). The ability to drive immediate adjustments requires understanding the motion profile characteristics.

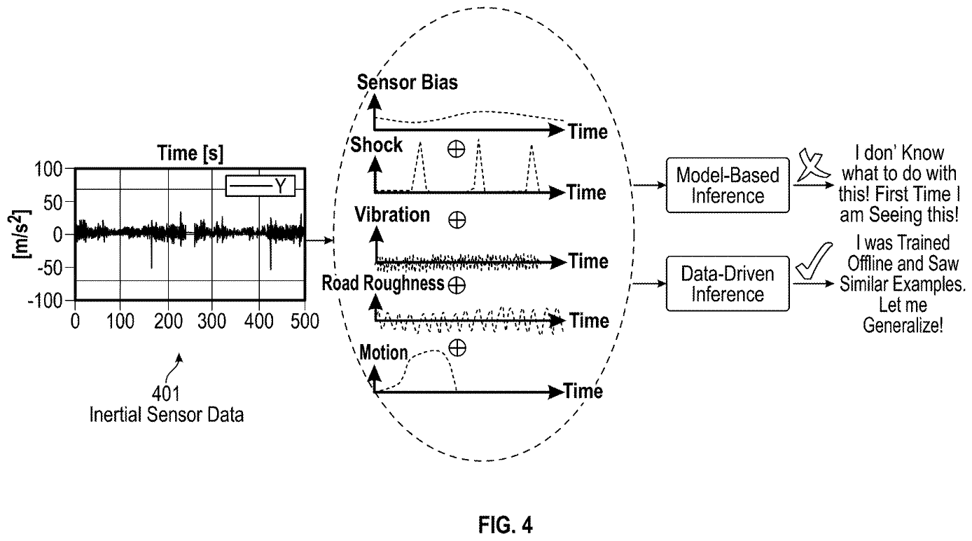

For example, in a maritime case, at a high tilt, a flat-panel electronically steered antenna (ESA) may experience outages due to loss of physical aperture or blockage by other platform parts. For instance, a part of a vessel may shadow the link between terminal and satellite when tilted. To guarantee a stable communication link, if the cause can be detected, the transmit power of received radio frequency front end (RFFE) may be ramped up to compensate for the lost aperture percentage. In another example, handoff to a different satellite/orbital plane/constellation may be initiated when shadowing occurs. This agile methodology depends on a reliable knowledge of a platform's motion profile to drive immediate decisions.

Whereas the examples on the significance of adaptive decision-making for A&T is abundant, there are two approaches to infer what is going on: the first is to exploit a variety of expensive sensors and cheap online algorithms; the second is to exploit as few sensors as possible to drive intelligent algorithms that come with a-priori knowledge of the possible scenarios. For example, using a vibration sensor along with LiDAR, radar, barometer, vision, wind, and tactical-grade sensors may be useful when cost, size, weight, and power are of no concern. Alternatively, algorithms with large expressive powers can be trained using sensory measurements collected offline from minimal sets of sensors which is then used to infer insight from these trained models in the field. For example, a combination of tri-axial gyroscope and accelerometer constitutes a sufficient set of sensory measurements to characterize the motion profile of a terminal. More importantly, the high sensitivity and sampling rate of many state-of-the-art commercial-off-the-shelf (COTS) inertial sensors are such that they can capture the effects that are exhibited by unintended causes. FIG. 4 better illustrates this concept.

FIG. 4 illustrates an example demonstrating how information about platform motion is embedded within inertial sensor measurements over time. As shown, raw inertial sensor data 401, such as accelerometer and gyroscope measurements, are collected while the communication terminal experiences motion resulting from intended or unintended forces.

Although individual samples of the inertial sensor data 401 may appear noisy or insufficient to clearly identify the underlying motion condition, the aggregate behavior of the sensor measurements over time reflects distinctive characteristics associated with different motion profiles. These characteristics may include vibration frequency content, amplitude variations, or rotational dynamics that are not readily observable from instantaneous measurements.

Therefore, platform motion characteristics are observable within long sequences of inertial sensor data, even when such characteristics are not explicitly labeled or directly measured. Embodiments disclosed herein exploit this observability by applying learning-based techniques to time-ordered inertial measurements to infer motion characteristics, via data-driven inference, that can be used to adapt acquisition and tracking behavior.

When paired with the dimension of time, sequences of inertial measurements in multiple dimensions can be obtained, the non-linear processing of which, in some embodiments, reveals useful information on the statistics of some of the contributing causes. This assumes that the observability criterion is satisfied, meaning the sensory data bears information about the quantity to be predicted. The systems and methods disclosed herein show such information is embedded (but deeply hidden) in long sequences of inertial sensory data, and hence, can be retrieved through data-driven learning techniques.

Embodiments disclosed herein include systems and methods for utilizing learning techniques on long sequences of inertial sensory measurements (as a minimum set of sensors) to gain distinctive clues about the characteristics of the motion to improve the robustness and precision of A&T-related tasks. In some embodiments, both unsupervised and supervised learning are used to train models of the predictive signal processing engine for predicting motion based on one or more motion profiles.

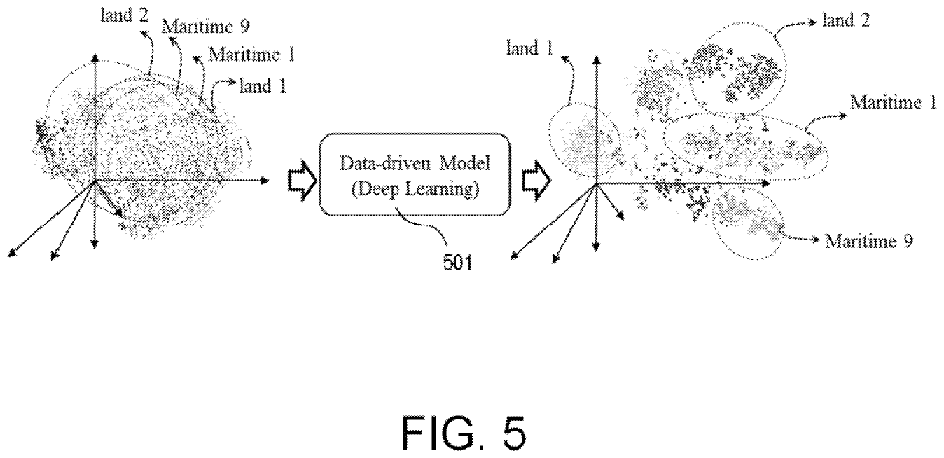

In general, the motion is an aggregation of multiple components generated by intended and unintended causal factors each affecting A&T tasks differently. FIG. 5 illustrates a conceptual comparison between raw inertial sensor data and learned latent representations corresponding to different motion profiles. Maneuvering in different environments creates motion profiles with distinctive features. Those distinctions are not evident in the sensory domain of the data as shown on the left side of FIG. 5. As shown on the left side of FIG. 5, time-ordered inertial measurements collected under different motion conditions may appear visually similar in the sensor domain, even when the underlying motion causes differ. In some embodiments, the presence of those underlying differences emerges through nonlinear hierarchical representation learning techniques. In some embodiments, a deep recursive architecture can potentially disentangle these factors of variation resulting in clustering of hidden features where each cluster represents a different motion profile. As illustrated on the right side of FIG. 5, application of nonlinear representation learning techniques may transform the raw sensor data into a feature space in which latent motion characteristics become separable. In some embodiments, a data-driven model 501 (e.g., deep learning) generates an output that disentangle these factors. In this learned representation space, clusters may emerge that correspond to different motion profiles, such as differing environmental conditions or platform behaviors.

In some other embodiments, instead of a data-driven model, a convolutional architecture is used. In such a case, the architecture uses the sequences to fixed-length vectors that are fixed and a multiplicity of diverse kernels to enforce parameter-sharing and preserve locality of correlations while reducing the number of parameters to be learnt.

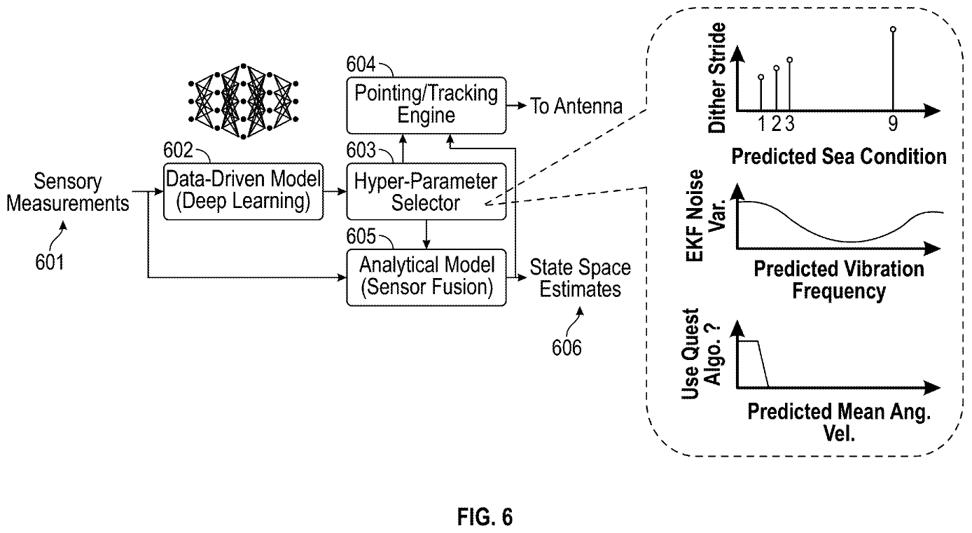

In some embodiments, with learning-based inference algorithms running in the backend of A&T algorithms, the inferences made on a pretrained data-driven model are utilized to adapt the hyper-parameters of several model-based A&T functions. For example, if the inference engine votes in favor of a severe maritime sea condition by processing a sequence of inertial sensory measurements, then the tracking engine can interpret this as evidence to increase the dithering stride to enhance tracking robustness. In some other embodiments, the statistics of the predicted angular velocity can be used to infer whether the underlying platform is rotating or is stationary. This determination is then exploited by the auxiliary estimators, such as, for example, but not limited to, the QUEST algorithm, to obtain an estimate of orientation by processing batches of pointing vectors at different times. This flow diagram of operation is depicted in FIG. 6.

Referring to FIG. 6, motion-related sensor data, sensory measurements 601, is collected by one or more inertial sensors associated with the antenna, such as, for example, accelerometers and gyroscopes, and provided as a time-ordered sequence to a predictive signal processing engine.

The predictive signal processing engine with data-driven model (e.g., deep learning model) 602 processes the sequence of motion sensor data 601 to generate an inference representing one or more motion characteristics of the antenna platform. In some embodiments, the inference takes the form of one of a motion profile classification, a regression output describing motion statistics, or a probabilistic representation indicating uncertainty among multiple possible motion conditions.

The output of the predictive signal processing engine is provided to a parameter selection or hyper-parameter selection module 603 (e.g., hyper-parameter selector 300 of FIG. 3). In some embodiments, the hyper-parameter selection module 603 is configured to determine one or more acquisition and tracking parameters based on the predicted motion characteristics. In some embodiments, the hyper-parameter selection module 603 does not alter the fundamental structure or algorithmic operation of an existing pointing and tracking engine, such as pointing/tracking engine 604, but instead selects values or modes of operation that are provided as inputs to that engine.

As further shown in FIG. 6, the selected parameters are provided to pointing/tracking engine 604, and its one or more acquisition and tracking sub-functions that control beam pointing behavior of the antenna. In some embodiments, analytical model (e.g., a sensor fusion model) 605 also receives sensory measurements 601 and, in response thereto, generates state space estimates 606 that are also provided to the pointing and tracking engine 604.

The selected parameters are used by one or more acquisition and tracking sub-functions of the pointing/tracking engine 604. Such sub-functions may include, by way of example and not limitation, beam scanning control, beam dithering control, beamwidth selection, beam dwell time selection, trajectory-based orientation estimation, or enabling or disabling auxiliary estimation routines. These sub-functions operate using the selected parameters to adjust how the antenna beam is formed, steered, or maintained during communication.

The acquisition and tracking functions generate control signals that are transmitted to the antenna hardware to effectuate the selected beam pointing adjustments. In this manner, predicted motion characteristics influence antenna behavior indirectly through parameter selection rather than by directly commanding antenna motion.

In some embodiments, the flow illustrated in FIG. 6 is executed repeatedly during operation of the communication terminal, such that updated motion sensor data results in updated predictions and corresponding updates to acquisition and tracking parameters. The repetition rate may be periodic, event-driven, or otherwise selected based on system constraints. The flow of FIG. 6 therefore enables proactive or adaptive tuning of acquisition and tracking behavior based on motion predictions, while maintaining compatibility with existing pointing and tracking algorithms.

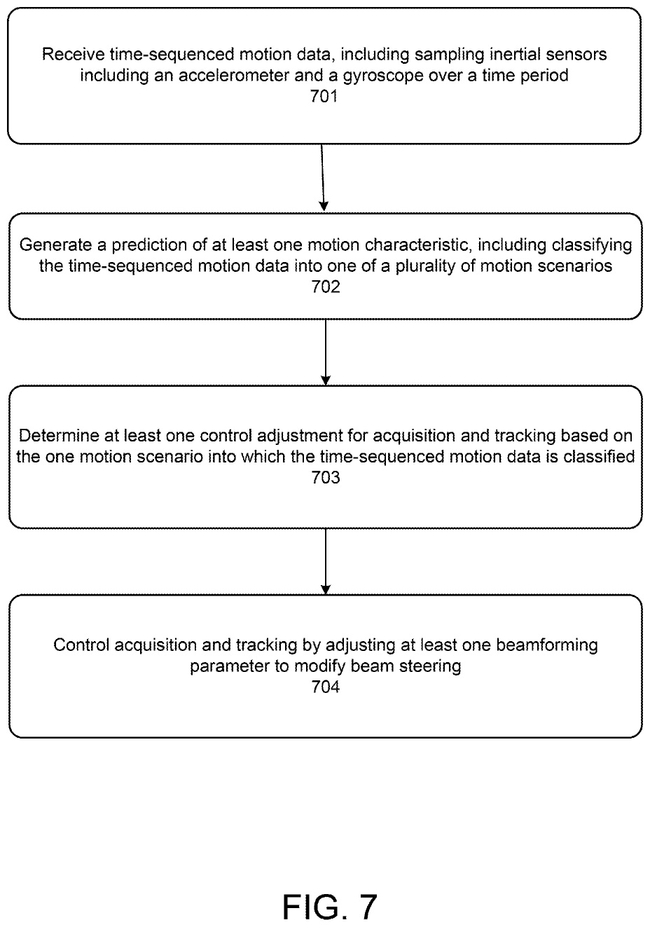

FIG. 7 is a data flow diagram of some embodiments of a process for controlling tracking & pointing for a communication terminal using a predictive model. In some embodiments, the process is performed, at least in part, by processing logic comprising hardware (e.g., circuitry, dedicated logic, etc.), software (e.g., software running on a chip, software run on a general-purpose computer system or a dedicated machine, etc.), firmware, or a combination of the three.

Referring to FIG. 7, the process includes receiving time-sequenced motion data, including sampling inertial sensors including an accelerometer and a gyroscope over a time period (processing block 701) and generating a prediction of at least one motion characteristic (processing block 702). In some embodiments, generating the prediction of at least one motion characteristic includes classifying the time-sequenced motion data into one of a plurality of motion scenarios.

In some embodiments, generating the prediction of at least one motion characteristic comprises regressing, with a regression model, one or more vibration statistics including frequency or amplitude. In some embodiments, generating the prediction of at least one motion characteristic comprises transforming the motion data using a spectral decomposition prior to inference. In some embodiments, generating the prediction of at least one motion characteristic comprises producing a low-dimensional embedding using an encoder trained by unsupervised learning and applying supervised learning using the embedding. In some embodiments, generating the prediction of at least one motion characteristic comprises using few-shot learning with clustering-based pseudo-label generation.

The process also includes determining at least one control adjustment for acquisition and tracking based on the one motion scenario into which the time-sequenced motion data is classified (processing block 703) and controlling acquisition and tracking by adjusting at least one beamforming parameter to modify beam steering (processing block 704). In some embodiments, controlling acquisition and tracking comprises increasing a tracking dithering stride. In some embodiments, controlling acquisition and tracking comprises changing beamwidth based on predicted vibration characteristics.

In some embodiments, both unsupervised and supervised learning are used to gain insight about the characteristics of the motion profile.

### Supervised Inference

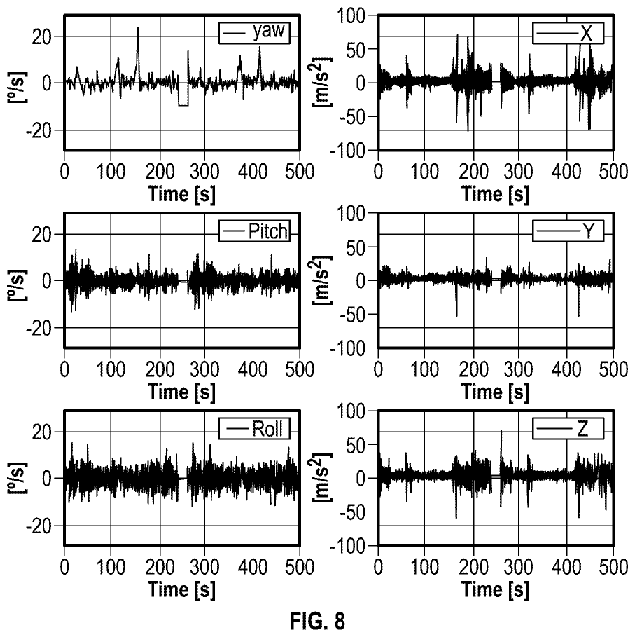

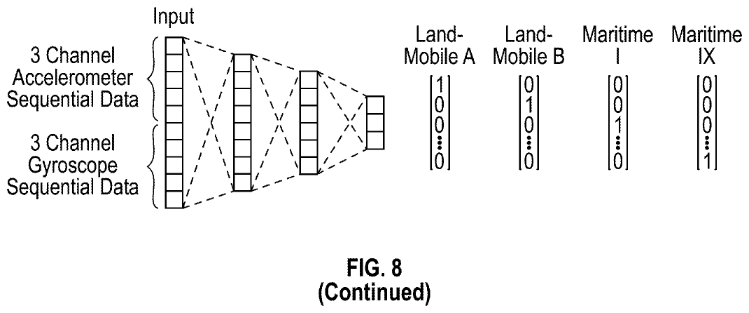

In supervised learning, labels or values that semantically describe the sensory data shown at the input are required. As a classical example, people often related to the binary classification problem where the learning network is trained to categorize different motion scenarios. In some embodiments, then through simple backpropagation algorithm and stochastic gradient descent (SGD) on a well-defined loss function, weights of a neural network are iteratively adjusted until no further improvement can be made. The number of classes (denoted as labels) can be large to include different motion scenarios. In some embodiments, the labels are similarly generated by a supervising human a-priori. In some embodiments, the labels are presented to the output through a one-hot encoding. The length of this encoding is such that it encompasses all the classes of interest. This is an example of the classification task. Assuming that the sensory measurements are long enough, they reveal the distinctive features of the motion in relation to which the measurements were collected as learning proceeds. FIG. 8 shows some embodiments of supervised learning being applied to predict a class of motion where only inertial sensory measurements are shown to the input. Some embodiments use inertial sensors inertial sensory measurements. In some other embodiments, inertial sensors are paired with vision sensors to detect a blockage. As shown, time-ordered sequences of inertial sensor measurements, such as, for example, three channel accelerometer sequential data and three channel gyroscope sequential data, are provided as inputs to a predictive model trained to classify the measurements into one of a plurality of motion profiles, such as, for example, land mobile A, land mobile B, maritime I, maritime IX, etc. In some embodiments, the predictive model comprises a neural network whose output layer produces a plurality of outputs, each corresponding to a different motion profile. During inference, the model generates an output indicating the predicted motion profile associated with the input sensor sequence. The predicted motion profile may be used to guide acquisition and tracking behavior, for example by selecting corresponding parameter values associated with the inferred motion condition.

In some embodiments where the input is presented to the learning network as sequences, a recurrent neural network (RNN) architecture, or any variant of it, such as, for example, long-term short-term memory (LSTM) or gated recurrent units (GRU), can be used. Additionally, in some embodiments, the architecture exploits the attention mechanism and transformer layer to better capture the long-term dependencies and avoid the diminishing/exploding gradient issues.

In the context of supervised learning, data is not only the raw sensory measurements but also the labels to describe the semantics of that measurement. Whereas obtaining the former can be automated using sensors, the latter often requires human intervention in the form of a supervisor annotating each sensory measurement with the label of the motion condition in which the measurement was captured.

In some embodiments, to facilitate the data collection and labelling task, in addition to data collected in the field, data is augmented through indoor and outdoor test captures, since the learning algorithm depends on seeing numerous different manifestations of motion for all scenarios and data collection/annotation may not be feasible (if not costly) all the time. For example, class 9-11 sea states are classified as life-threatening conditions. Those scenarios for which data collection is more challenging might be precisely the ones where having a well-established communication link is needed.

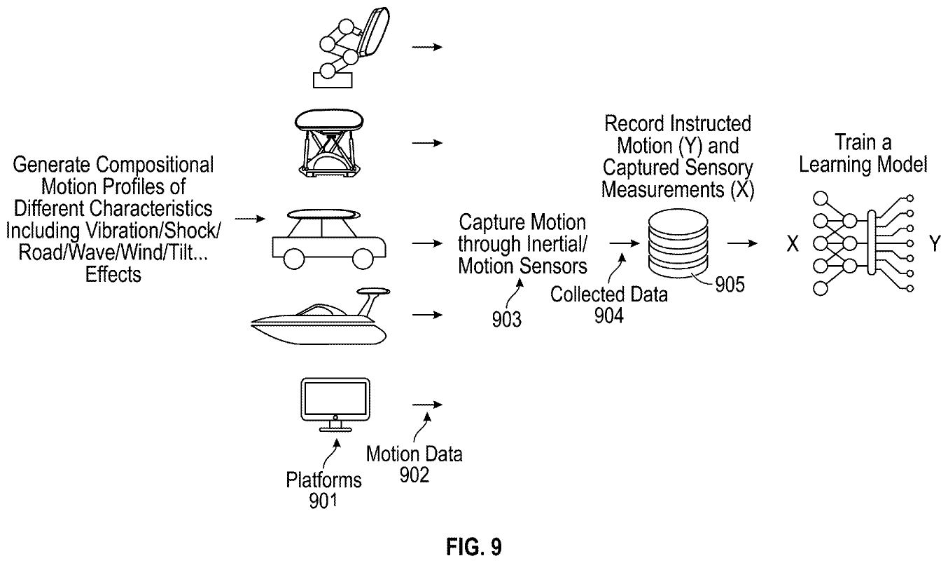

Lastly, data may also be synthetically generated through simulation. When what constitutes a particular motion has been identified, that information is synthesized and reproduced through, for example, robot manipulators or in a simulation environment. This notion is shown in FIG. 9 where an antenna is mounted on multiple platforms including a robot (controlled indoor), on a hexapod (controlled outdoor), on a vehicle (semi-controlled outdoor). After each collection, the data is preprocessed (e.g., denoising, removing redundancies, segmentation . . . ) before entering the training phase. FIG. 9 illustrates examples of platforms used to collect motion data for training and evaluation of predictive models. Referring to FIG. 9, motion data 902 may be collected from antennas mounted on various platforms 901, including controlled robotic systems, outdoor test rigs, and operational vehicles (e.g., automobiles, maritime vessels, etc.). These platforms 901 enable collection of inertial sensor data under a wide range of controlled and uncontrolled motion conditions. In some embodiments, the collected data 904 represents motion data 902 captured through inertial/motion sensors 903. The system records, in memory, motion data (Y) and captured sensory measurements (X) (905). The collected data 904 may be preprocessed, segmented, and labeled prior to use in training supervised or unsupervised predictive models. After recordation of the data, training of the predicted models using the recorded data.

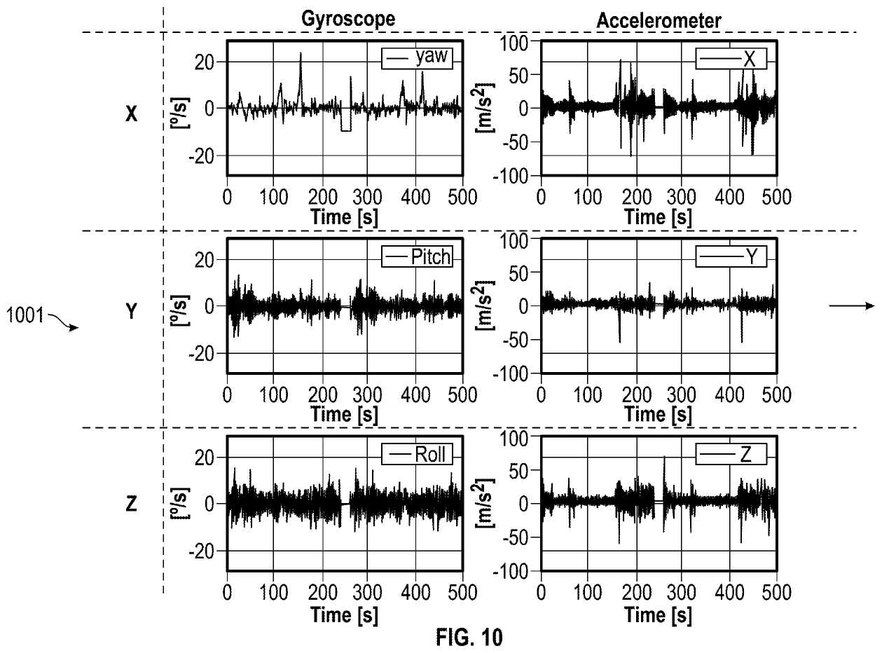

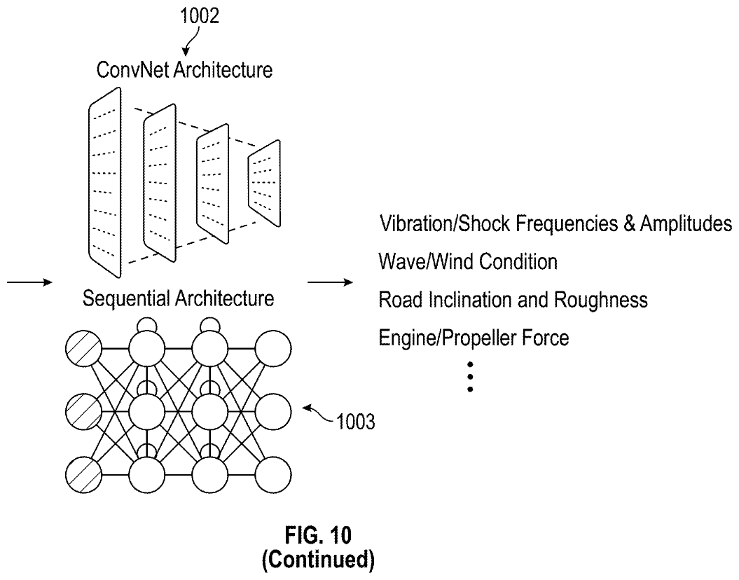

The above discussion involved a classification task where the inference engine, in the most idealistic case, can correctly predict the condition in which a sequence of sensory measurements was collected. In many scenarios, the statistics of the motion components are of most interest, a level of inference that is more intricate than the classification task. This can be cast as a regression problem where a continuous variable is to be predicted. For example, there may be interest in knowing the vibration/shock frequencies and amplitudes superimposing the accelerometer readings or road inclination/roughness level. A deep architecture may be utilized to solve the problem. FIG. 10 illustrates an example regression-based predictive architecture for inferring continuous motion characteristics from inertial sensor data. Referring to FIG. 10, time-ordered sequences of inertial measurements 1001 are processed by a predictive model. In FIG. 10, the axes labeled X, Y, and Z correspond to physical sensor dimensions. In some embodiments, the predictive model includes ConvNet architecture 1002 and sequential architecture 1003, which are configured to output one or more continuous motion parameters, such as vibration/shock frequencies, wave/wind conditions, road inclination and roughness, angular velocity statistics (e.g., engine/propeller force), etc. In some embodiments, the predictive model learns a mapping from high-dimensional sensor sequences to lower-dimensional motion characteristics, enabling estimation of motion statistics that are not directly measured by the sensors.

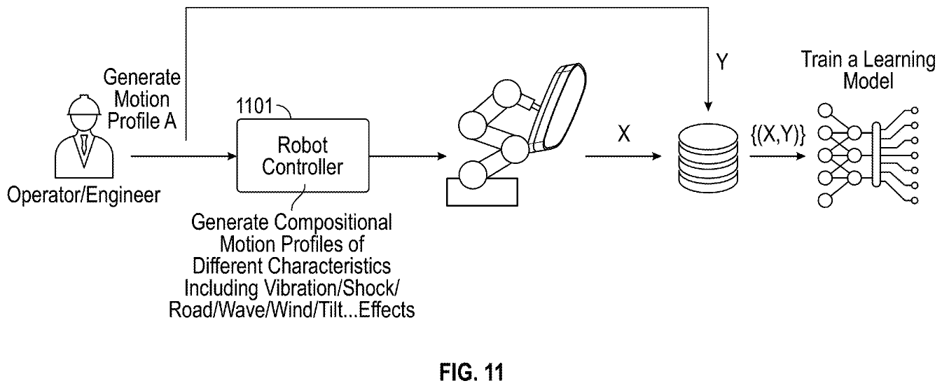

If the input sensory data has a sufficient number of data values, the system can learn the aforementioned statistics. However, the learning requires a different level of annotation in this case. Concretely speaking, it is no longer possible to rely on an operator to guess the statistics of the motion profile components as was the case for classification. This makes the uncontrolled outdoor collection not feasible unless there are dedicated sensors (e.g., vibrometer, inclinometer, anemometer, barometer, and the like) onboard the data collection platform (e.g., vessels, vehicles, etc.) to record the output statistics while input is provided by inertial sensors. One can rely on controlled testing methodology where an operator instructs the motion controller to generate a motion profile and execute that. The controller knows a-priori what a particular motion profile means in terms of the level of vibration, shock, rocking due to wind-speed, movements due to waves, and so on. Therefore, the motion controller generates a motion that captures these effects. The aggregate executed motion is then captured by inertial sensors onboard the antenna control unit (ACU). Once the latter is collected for sufficiently long time, the collected motion sensory data is labelled with the category of the motion profile that the operator instructed/generated. Some embodiments of this process is continued until a comprehensive dataset is established. FIG. 11 illustrates an example of such a process for generating labeled motion data for training regression models. Referring to FIG. 11, an engineer, via a motion controller, generates known motion profiles, such as motion profile A and sends it to a robot controller 1101. The motion controller sends the motion profile for execution by a test platform, and the resulting motion is captured by inertial sensors mounted on the antenna. The known motion parameters generated by the controller are used to label the corresponding inertial sensor data, thereby producing training datasets suitable for supervised learning of motion statistics in order to train a predictive model. In FIG. 11, the axes labeled X and Y represent multi-dimensional input and output vectors of the predictive model.

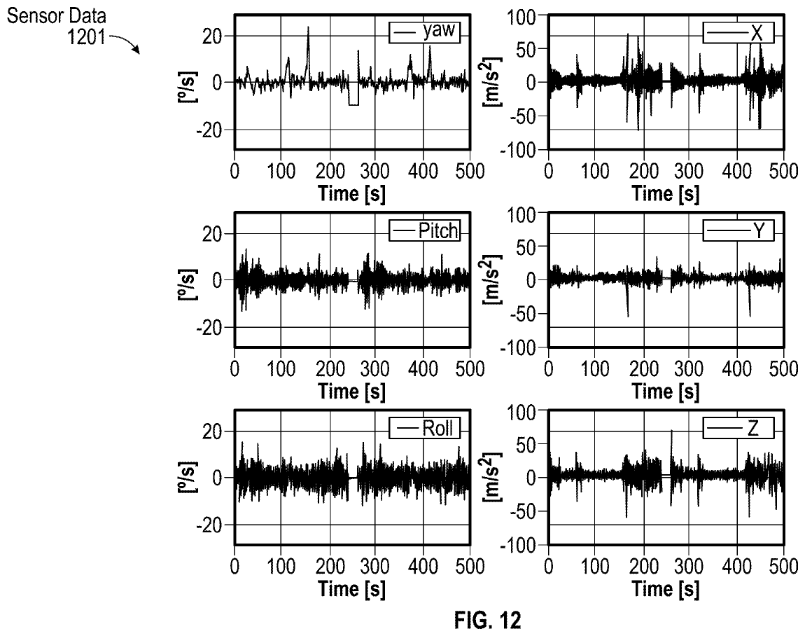

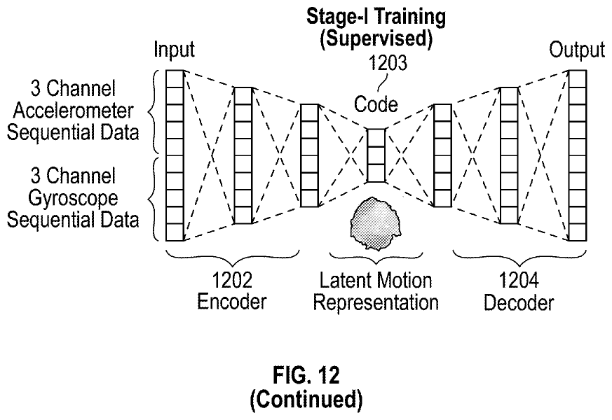

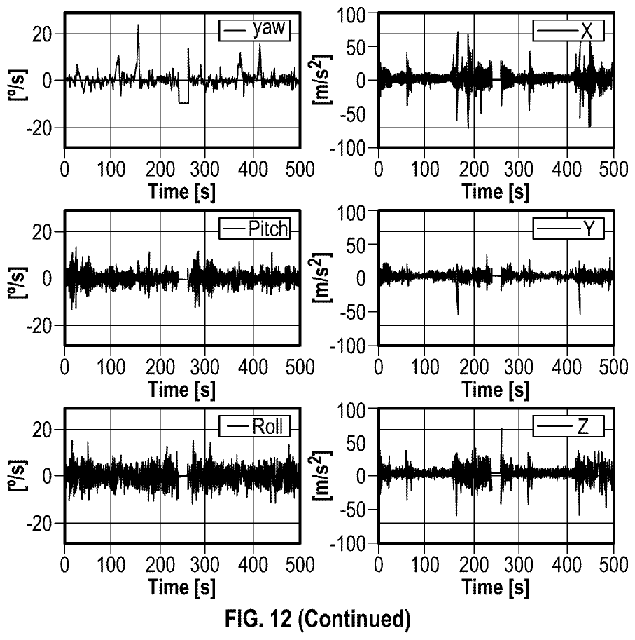

In some embodiments, a multi-stage learning architecture is implemented where a proper data embedding is first found through unsupervised learning which is followed by supervised learning. This task, referred to herein as transfer-learning, is often advantageous when data is scarce or labelling is a difficult undertaking. The goal of transfer-learning with the techniques disclosed herein is first learning a low-dimensional feature space from inertial data that possibly entails important factors of variations in data that are possibly disentangled through the unsupervised learning step. In some embodiments, different variants of autoencoders (AE) such as, for example, denoising or sparse AE, are examined to learn the aforementioned representation. FIG. 12 illustrates an example of such a process for generating labeled motion data for training regression models. Referring to FIG. 12, an encoder 1202 compresses time-ordered inertial sensor data 1201 (e.g., three channel accelerometer sequential data and three channel gyroscope sequential data) into a lower-dimensional latent motion representation, code 1203, while a decoder 1204 attempts to reconstruct the input data from the latent representation. Training the autoencoder enables the model to learn compact feature representations that capture dominant factors of variation in the motion data while reducing redundancy and noise.

The funnel shape of an AE, when paired with hierarchical and non-linear distributed architecture of both encoder and decoder, yields a feature space (a.k.a., latent representation) that captures only the most important factors of variation in data while eliminating the correlated dimensions. This dimensionality reduction is beneficial to the next stage that is supervised in the sense that fewer numbers of labelled motion data are now required. This is intuitive as compressing the input data to a low-dimensional subspace makes it easier for the learning algorithm to find good separating hyperplanes to correctly classify the data in feature space.

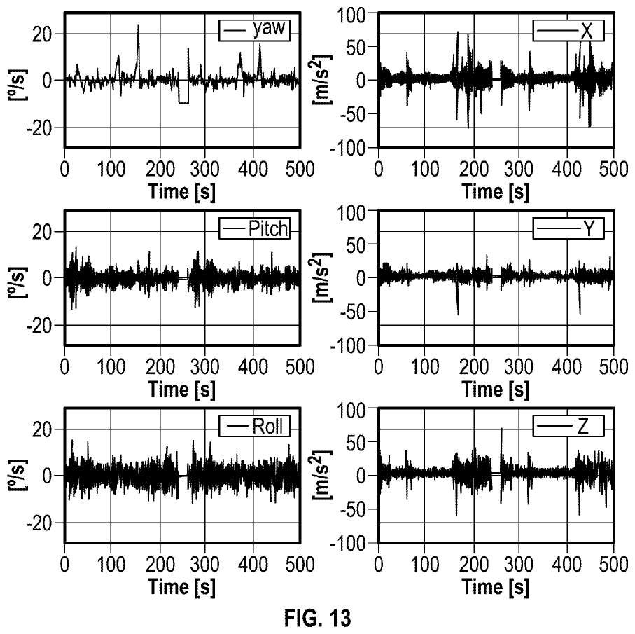

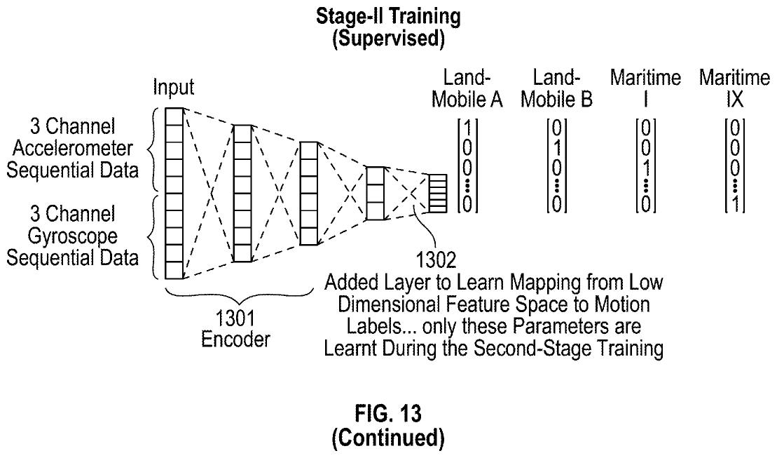

In the second stage of training, the decoder part of the AE is disposed while the encoder part is kept and concatenated with a few more layers. During this stage of training, only the weights of the concatenated layers are trained during backpropagation while the encoder weights remain fixed. FIG. 13 illustrates an example of supervised stage-II training. Such training can follow the unsupervised training of FIG. 12. Referring to FIG. 13, the decoder portion of the autoencoder is removed after unsupervised training, and the encoder 1301 is reused as a feature extractor.

The extracted latent representations are provided to additional layers 1302 trained using supervised learning to perform motion classification or regression, thereby reducing the amount of labeled data required. The added layer is used to learn a mapping from the dimensional feature space to motion labels. In some embodiments, only these layers are used during the second stage of training. The output of the supervised stage-II training is multiple motion profiles, such as, for example, land mobile A, land mobile B, maritime I, etc.

The transfer learning approach is very effective in reducing the amount of labelled data and in steering the architecture towards learning underlying data representations. The same methodology can be applied to the aforementioned regression problem where cost of obtaining labels from field measurements can be very high.

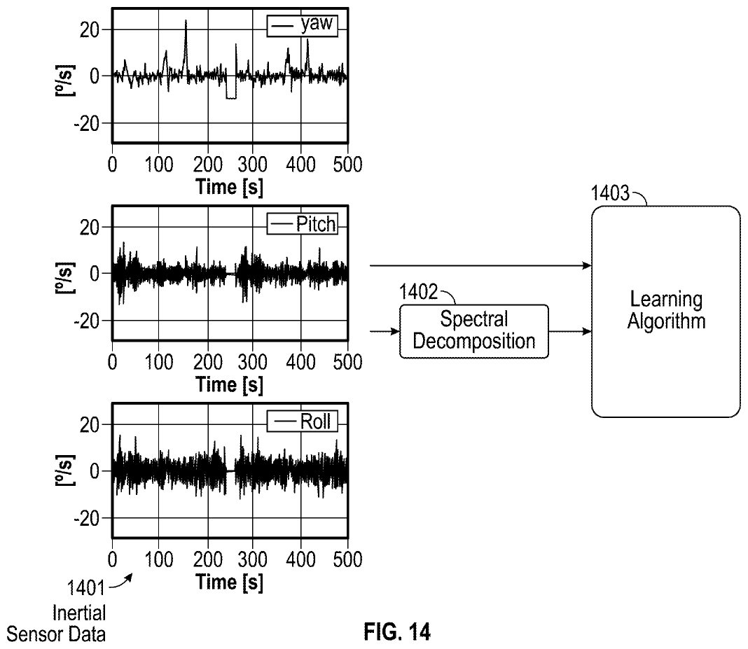

In some embodiments, the input data shown to the learning algorithm entails a transformation of the raw sensory measurements. In some embodiments, this transformation is the multi-dimensional spectral decomposition of the sensory data as shown in FIG. 14. More specifically, FIG. 14 illustrates an example transformation of inertial sensor data into the spectral domain. As shown, time-ordered motion measurements 1401 (e.g., inertial sensor data) are transformed using spectral decomposition techniques, such as, for example, Fourier transforms, to expose frequency-domain features associated with different motion components. Spectral representations may provide more separable or informative features than time-domain data for certain motion conditions. The resulting spectral decomposition 1402 and the motion measurements 1401 are provided to a learning algorithm 1403.

An objective for such pre-processing is to guide the learner towards a better optimality point by implicitly showing it a more disentangled and parsimonious representation of the data. This is because many of the motion components have more distinctive features in spectral domain than temporal domain.

Some embodiments disclosed herein are related to few-shot learning. The few-shot learning is an extreme case of annotated data scarcity. The goal initially is to cluster the motion data in the label domain rather than classifying it; that is, training the neural network without labels. Pseudo-labels derived from clustering are used to guide subsequent supervised training, and a limited number of labeled samples may be used to refine or associate semantic meaning with the learned clusters.

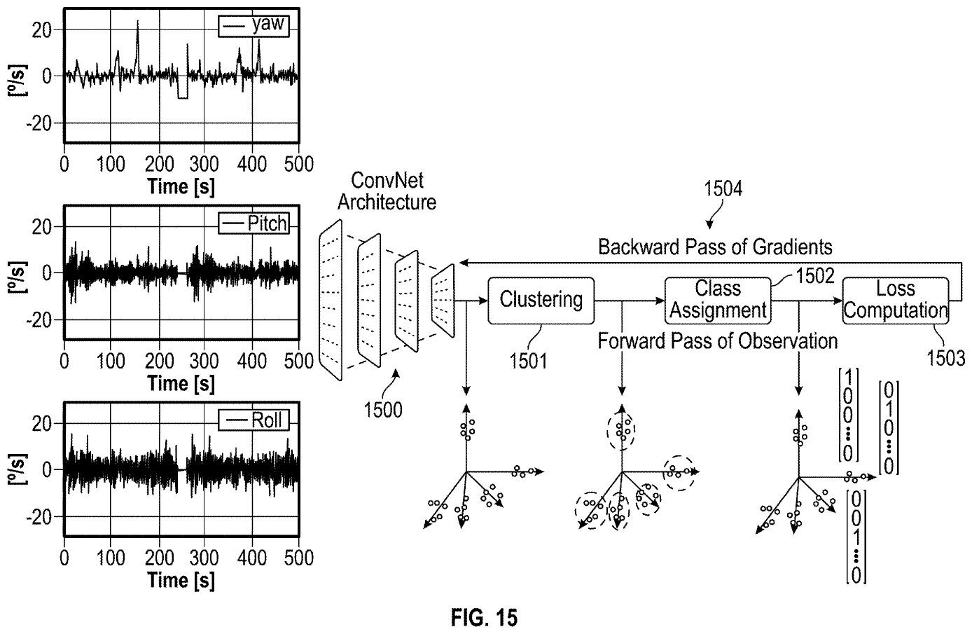

FIG. 15 illustrates an example of a few-shot learning architecture for motion profile prediction. Referring to FIG. 15, the predictive model, such as using ConvNet architecture 1500, is initially trained without explicit labels by clustering outputs, using clustering module 1501 generated during early stages of inference. In some embodiments, in the case of a deep learning classifier that just started getting trained using minibatches of Stochastic Gradient Descent (SGD), there is one output label for each sensory input in the minibatch generated by forward-pass through the (yet untrained) model. Once all data inputs in minibatch are propagated to the output, a clustering algorithm executed by clustering module 1501 tries to cluster these output samples into several classes. In some embodiments, the clustering algorithm is K-means. In some other embodiments, the clustering algorithm is as advanced as hierarchical or spectral clustering. At the output of the clustering module 1501, sensory inputs are clustered. This, in turn, is passed to a class assignment module 1502 to create pseudo labels for each output. Once these pseudo labels are available, training of the neural network through backpropagation (1504) is pursued using standard loss functions such as, for example, cross-entropy (for classification) or quadratic loss (for regression). As the training proceeds, disjoint clusters are expected to emerge at the output.

Once the cross-validation loss stops improving, as indicated by loss computation module 1503, the end of the first step of the training is declared where some level of disentanglement was introduced among the classes. The next stage is to determine which output cluster maps to which motion profile. This means that in some embodiments a second stage of training through a few labelled samples is used to color the clusters with the correct labels.

In some other embodiments, this architecture can be modified to remove the clustering step and introduce a compound loss function that constitutes a quadratic loss as well as a clustering loss. Both of these embodiments may suffer from some performance loss due to not knowing the ground-truth (GT) motion-profile labels. However, the learning will follow to the extent that useful information can be inferred.

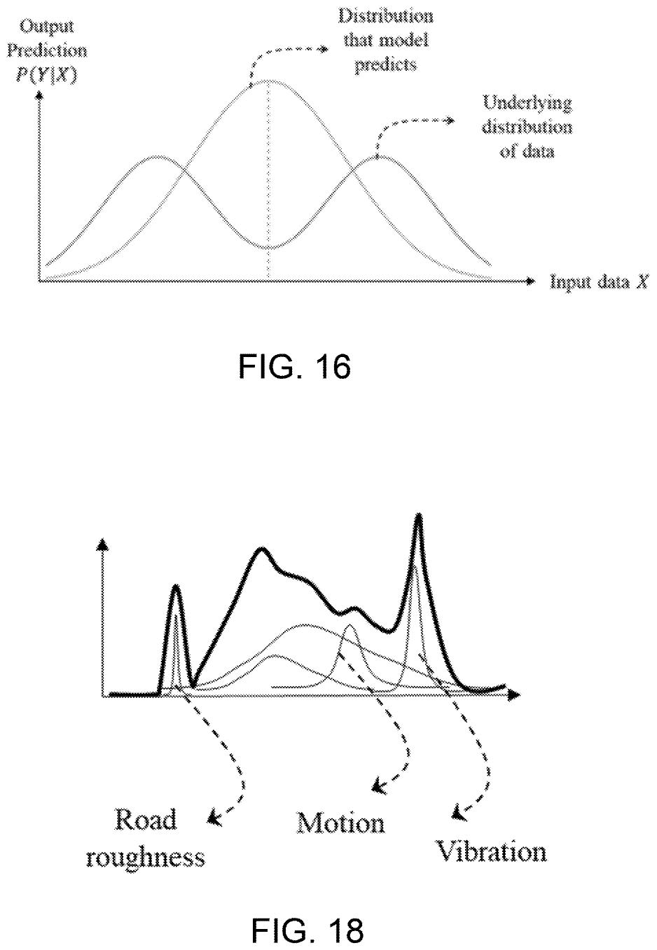

In some circumstances, the input data is not uniquely descriptive of the output labels. For example, a sequence of tri-axial gyro and accelerometer measurements may distinguish between maritime sea conditions 1, 5, 11, but the conditions in between are not resolvable by modern-time deterministic learning algorithms because of the similarity of the factors of variation (FoVs) of the classes 2,3,4 with class 1 and 6,7,8 with class 5. When this occurs, non-probabilistic classification fails to deliver reliable predictions. This is because a non-probabilistic model that minimizes the cross-entropy or quadratic loss can be deemed as a probabilistic model that maximizes the likelihood of a multi-variate Gaussian distribution P(Y|X) where X,Y are input sensory data and labels, respectively. If the underlying conditional distribution P_GT (Y|X) is truly Gaussian, then the training model is expected to be a good predictor given a sufficient amount of data. But if the input sensory data does not uniquely explain classes, then the above-mentioned conditional distribution will be multi-modal. In this case, a non-probabilistic model that uses cross-entropy or quadratic loss is not expressive enough to find the best fit to the motion data even if the model has large capacity. FIG. 16 illustrates this problem for 1D input data where inertial sensor data does not uniquely correspond to a single motion profile. Referring to FIG. 16, similar sensor measurements may arise from multiple underlying motion conditions, resulting in ambiguity that limits the effectiveness of deterministic classification models. This ambiguity motivates probabilistic inference techniques that account for uncertainty in motion prediction.

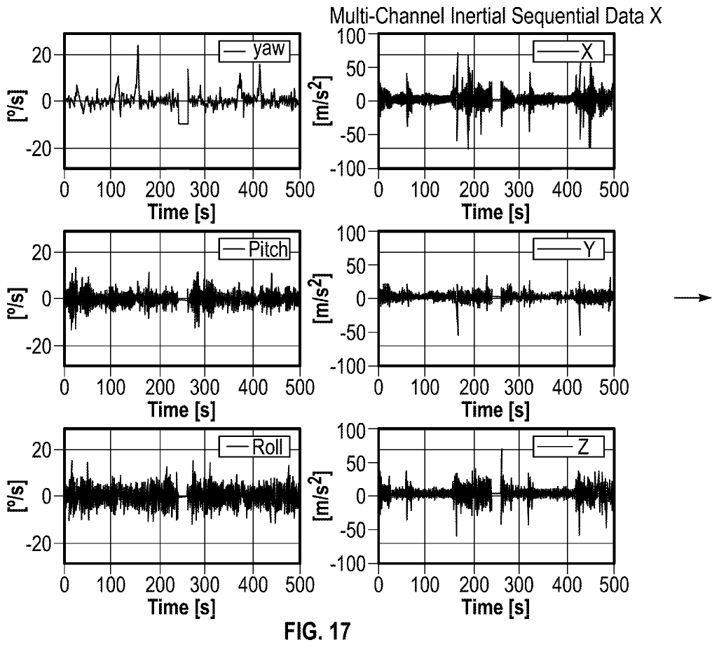

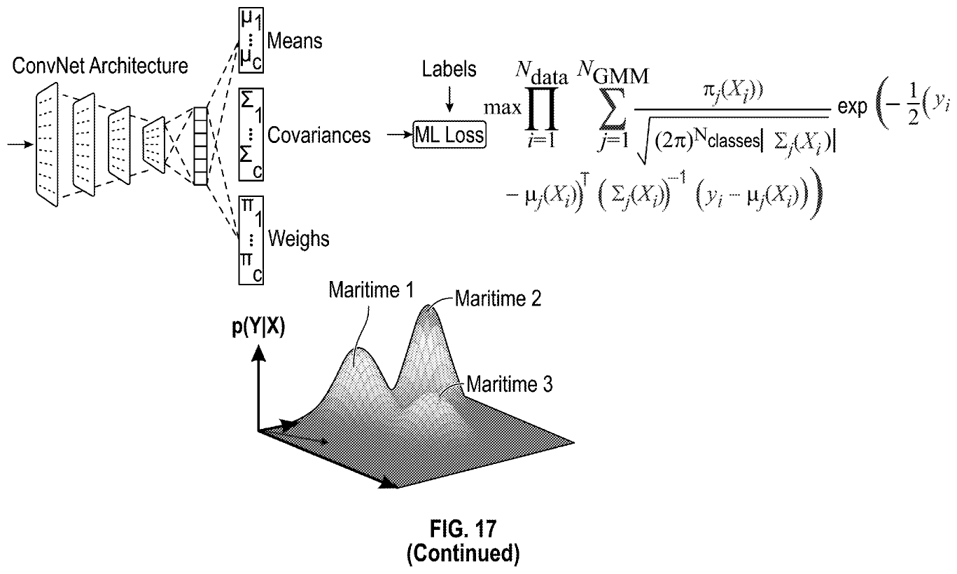

In some embodiments, the motion-profile learning is applied to a probabilistic supervised model with the conditional distribution is forced to be a mixture of Gaussians. The Gaussian mixture model (GMM) has more expressive power and can better fit the data when the aforementioned ambiguities exist. In some embodiments of this architecture, the output of a model is not the label but rather the parameters of a GMM to be learned. In some embodiments, parameters include means, covariances, and mixing coefficients for different mixture components. FIG. 17 illustrates this architecture.

In some embodiments, the predictive signal processing engine outputs a probabilistic representation of motion characteristics rather than a single deterministic classification. For example, the predictive signal processing engine may output parameters of a conditional probability distribution, such as means, variances, or mixture weights of a Gaussian mixture model, that characterize uncertainty associated with one or more possible motion profiles.

Such probabilistic outputs may be used by downstream acquisition and tracking modules to select parameter values that account for uncertainty in the predicted motion state. For instance, greater uncertainty in predicted motion conditions may cause the acquisition and tracking subsystem to select parameter values that are robust across multiple motion scenarios, whereas lower uncertainty may permit more aggressive optimization of pointing performance.

### Unsupervised Learning

In circumstances where data annotation is not possible, there is still a way to learn clues from unlabeled sensory data. In some embodiments, the unsupervised learning for a model used by the predictive signal processing engine, is based on the existence of some transformation of the input motion data that is sparser compared to the original sensory domain. The spectral transformation is one example where different causal factors affecting motion leave local signatures at different portions of spectrum. This is illustrated in FIG. 18, where sparse but unresolvable spectral components (unobserved) contribute to the aggregate effect that is observed. This aggregate effect, shown as the bold line in FIG. 18, is what is observed. The model reconstructs the missing spectral components based on learned features, enabling resolution of latent motion components that overlap in the observed signal. This approach allows recovery of motion information that may not be resolvable using linear spectral analysis techniques alone.

The Fast Fourier Transform (FFT) is unable to achieve super-resolution on the input data due to its linear nature. If there were a way to recover the latent (unobserved) components from this aggregate spectral content, then a model-based inspection of each component can potentially reveal useful information on what causal factors contributed to it. This super-resolution can be achieved through a non-linear and deep learning paradigm. In some embodiments, an autoencoder on some form of transformation of sequential input sensory data is trained. In some embodiments, spectral decomposition, such as Fourier Transform (FT), is used for the transformation. Training on such a model captures the important factors of variation in data. In the inference phase, different parts of the spectrum (for instance by filtering) of unseen data are masked and shown to the trained model. The AE will try to reconstruct the manipulated data based on the learned features. The result is that what comes out of the AE, during inference stage, can resolve components better than the analytical models. When this is achieved, the expert system exploits some a-priori knowledge along with the output of the inference engine to deduce insights about the underlying causes of motion.

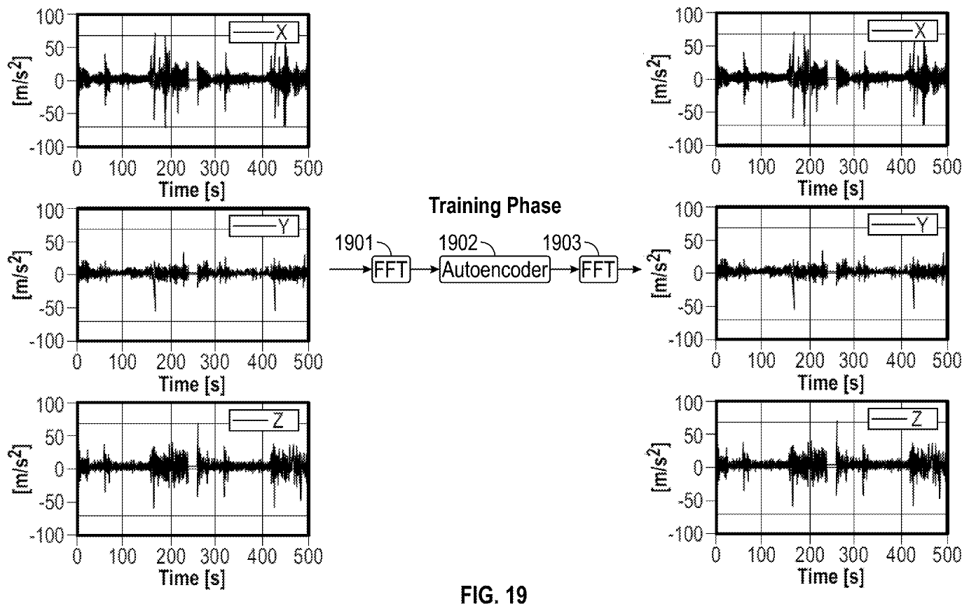

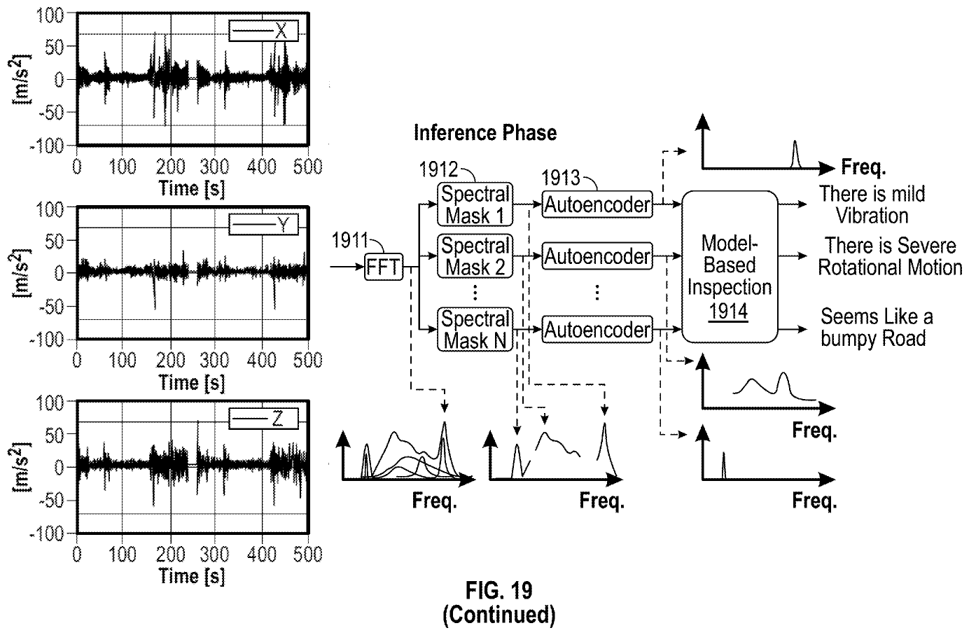

FIG. 19 illustrates such an unsupervised inference approach for resolving latent motion components from spectral representations of inertial sensor data. Referring to FIG. 19, as part of a training phase, time-ordered inertial sensor measurements are transformed into a spectral representation, for example using a FFT 1901 (or similar decomposition technique), followed by an autoencoder 1902 (to reduce the dimensionality of data by learning a compressed representation in the latent space), and then to another Fourier Transform 1903. In some embodiments, portions of the spectral representation are selectively masked, filtered, or removed prior to being provided as input to a trained unsupervised model. The unsupervised model, such as the autoencoder 1902 (or other deep reconstruction network), has been previously trained to learn latent structure in the spectral domain of motion data.

During an inference phase, the model attempts to reconstruct the masked spectral components based on learned features corresponding to underlying motion characteristics. By reconstructing missing or attenuated portions of the spectrum, the model effectively separates overlapping or unresolved motion components that contribute to the observed sensor measurements. In the case of FIG. 19, an FFT 1911 receives long sequences of motion data and converts the data from the time domain into the frequency domain. A series of spectral masks 1-N (1912) regulates the power levels of the output of FFT 1911 across different frequencies. The outputs of the spectral masks 1912 are input to a series of autoencoders 1913, followed by model-based inspection module 1914, which analyzes the data to infer characteristics of the underlying motion causes. That is, the reconstructed spectral information may then be analyzed, either by automated logic or by an expert system, to infer characteristics of the underlying motion causes, such as sources of vibration, rotational dynamics, or environmental disturbances. FIG. 19 therefore illustrates an embodiment in which motion characteristics are inferred in a fully unsupervised manner, without requiring labeled training data, by exploiting learned structure present in spectral representations of inertial sensor data. Thus, as shown, this approach is completely unsupervised.

### Motion Synthetization

This subsection discloses a core idea underlying synthetization of sensory motion data through a learning-based generative paradigm. As discussed above, the augmentation of data in indoor/outdoor controlled test environments or through simulation are discussed. With that, a model is available a-priori to generate the motion. In other words, the underlying cause of motion needs to have been discovered and modeled already. There are occasions where there is no a-priori knowledge of what causal phenomena constitutes certain motion and how they interact. For example, it may be known that vibration and shock can be introduced due to tire flatness or axle imbalance but not know that engine malfunction might be a bigger contributor to what is experienced as vibration. If the latter situation is ignored, the simulated motion will not resemble reality.

In some embodiments, an unsupervised generative model is trained on real-world data. A generative model can learn the underlying distribution of motion data, denoted by P(X). Deep architectures can achieve this by redefining the loss function in different ways. Perhaps the first successful proposition of generative models was by combining the variational inference with autoencoder to build variational autoencoder (VAE). In some embodiments, the generative model is an autoregressive model. The deep generative models depend on discovering good high-level representation in deeper layers of network and sampling in that space to generate synthetically generated sensory data in the sensory domain.

In some embodiments, the training of the generative models is purely unsupervised, meaning no human intervention is required to label the data. Once training is complete, the decoder (in case of VAE) or generator (in case of GAN) part of the model is used to generate synthetically generated sensory data. This synthesized data is then fed to the test setup to create motions that are more realistic. Antennas can be tested with these motions to characterize their performance.

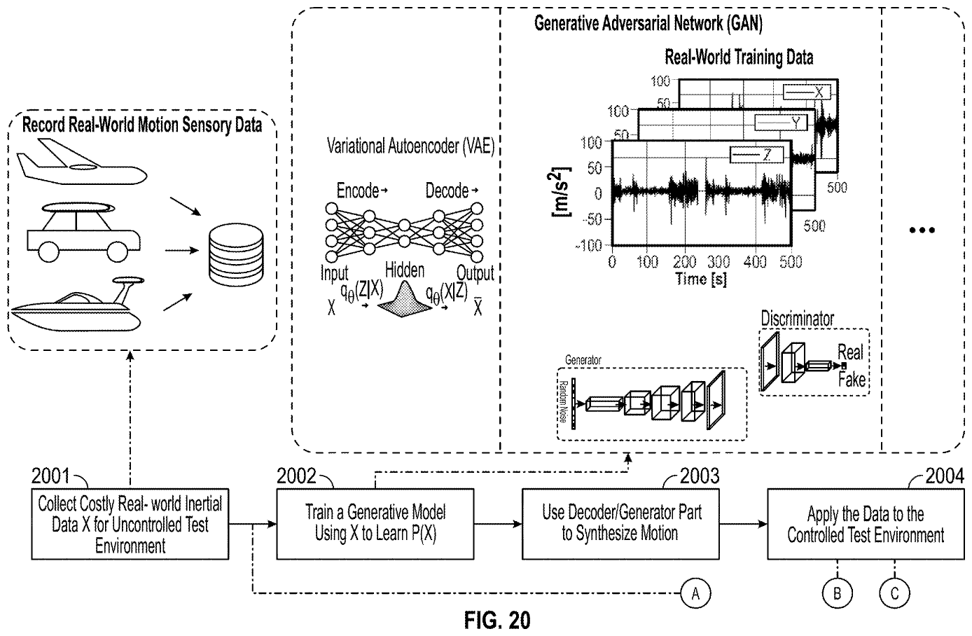

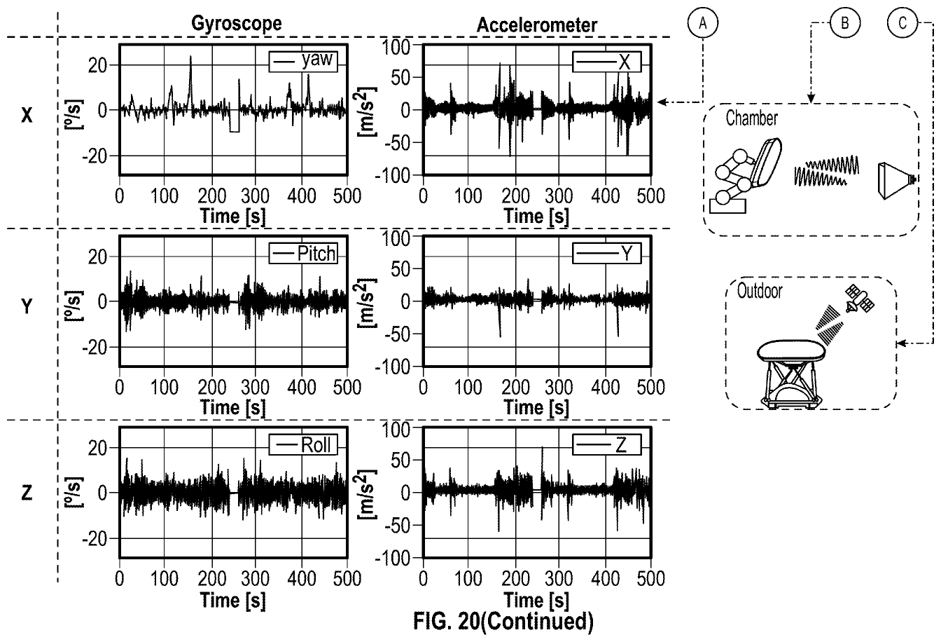

FIG. 20 illustrates an example embodiment for synthesizing motion sensor data using a learning-based generative model. Referring to FIG. 20, an unsupervised generative model is trained using real-world inertial sensor data 2001 collected from one or more antennas operating under actual motion conditions. In some embodiments, sensor data 2001 is collected for an uncontrolled test environment. This data is provided to a generative model 2002.

The generative model 2002 learns an underlying distribution of the motion data, capturing latent structure and statistical characteristics associated with real platform motion. In some embodiments, the trained generative model 2002 comprises a variational autoencoder, an autoregressive model, a generative adversarial network, or another deep generative architecture.

After training, the generative model is used to generate synthetic inertial sensor data using a decoder/generator 2003 that exhibits characteristics consistent with real motion conditions. The synthesized motion data may be provided to a test environment 2004, simulation framework, or motion controller configured to execute corresponding physical motion, such as via a robotic platform or mechanical test rig.

The synthesized motion data and corresponding executed motion may be used to evaluate antenna performance, acquisition and tracking behavior, or robustness under motion scenarios that are difficult, costly, or unsafe to reproduce using real-world data collection. In this way, learning-based generative modeling enables augmentation of motion datasets and testing of communication terminals under a broad range of motion conditions.

### Other Use Cases

The techniques disclosed herein have application aside from A&T. In some embodiments, a learned motion profile of the user terminal is used not only to adapt antenna acquisition and tracking parameters, but also to adapt communication, RF front-end (FE), waveform, beam management, sensing, positioning, and/or diagnostic functions of the terminal. For a first example, in some embodiments, in the case of application to RF front-end adaptation, the model predicts whether the terminal is in a high-dynamic, vibrating, turning, or stable state, and the RF front-end adapts accordingly. The following table describes an example of motion profile predictions and a corresponding RF front-end adaptation:

| Motion- | |
|---|---|
| profile prediction | RF-FE adaptation |
| High vibration or | Increase AGC responsiveness |
| rapid angular motion | |
| Stable terminal | Use slower AGC/longer averaging |
| Rapid beam motion | Adjust LNA/VGA gain margins to |
| expected | avoid clipping during signal swings |
| High risk of fades | Change power detector averaging or |
| due to motion | thresholding |
| Predicted Doppler | Adjust frequency-tracking loop |
| dynamics | bandwidth |
| Predicted blockage/ | Preemptively adjust gain state or |
| shadowing event | signal detectiont hresholds |

Given the fact that motion can create rapid received-power fluctuations, Doppler dynamics, and beam-gain variation, in some embodiments, the RF chain is adapted before the signal quality degrades. The predicted motion profile is used to adjust one or more RF front-end parameters, including gain-control settings, AGC time constants, LNA/VGA gain states, power detector integration time, ADC dynamic range settings, frequency-tracking loop bandwidth, carrier-recovery loop bandwidth, and/or signal-detection thresholds.

For a second example, in some embodiments, in the case of application to modem/physical (PHY)-layer adaptation, the motion profile predicted by the model can affect the modem even if the antenna remains locked. For example, high motion can cause: faster SINR variation, faster Doppler/range-rate change, phase noise-like residuals, deeper short fades, and/or more frequent reacquisition risk. In such a case, based on the motion profile by the model, the terminal could adapt modem parameters. The following table describes an example of motion profile predictions and a corresponding modem/PHY adaptation:

| Motion prediction | Modem/PHY adaptation |
|---|---|
| Stable motion | Higher-order modulation/coding, longer |
| | averaging |
| High dynamics | More robust MODCOD |
| Rapid Doppler | Wider carrier-recovery loop bandwidth |
| variation | |
| Strong vibration | Shorter channel-estimation window |
| Predicted fade | Increase coding robustness or interleaving |
| Predicted stability | Reduce pilot overhead or tracking overhead |

Thus, in some embodiments, the motion-profile prediction is used to adapt modem parameters, including modulation and coding selection, carrier-recovery loop bandwidth, timing-recovery loop bandwidth, pilot density, channel-estimation interval, interleaver depth and/or coding rate, equalizer coefficients, and/or packet retransmission thresholds.

For a third example, in some embodiments, in the case of application to transmit (Tx) power/EIRP control adaptation, the motion profile predicted by the model can affect the transmit power. In some embodiments, when the terminal motion is stable, the system operates closer to nominal link margin, and when motion is dynamic, the system adds margin or reduce risk of off-axis emissions. The following table describes an example of motion profile predictions and a corresponding Tx adaptation:

| Motion prediction | Tx adaptation |
|---|---|
| Stable pointing | Normal transmit power |
| High pointing | Reduce Tx power until pointing |
| uncertainty | confidence improves |
| Predicted | Mute, back off, or limit EIRP |
| mispointing event | |
| Predicted fade | Temporarily increase link margin |
| due to motion | if allowed |
| High off-axis risk | Enforce stricter PSD/EIRP limits |

Thus, in some embodiments, the predicted motion profile is used to adjust transmit power, EIRP, spectral-density limits, uplink burst timing, and/or transmit enable/disable thresholds based on predicted pointing uncertainty or predicted off-axis emission risk.

For a fourth example, in some embodiments, in the case of application to integrated sensing and communication/positioning, navigation, and timing (PNT) use adaptation, the motion profile predicted by the model can affect sensing and PNT subsystem. In some embodiments, motion learning can help the sensing/PNT subsystem in several ways. Note that if the terminal predicts high dynamics, it may need more frequent measurements. The following table describes an example of motion profile predictions and a corresponding sensing/PNT adaptation:

| Motion prediction | Sensing/PNT adaptation |
|---|---|
| Stable motion | Lower measurement rate |
| High acceleration | Higher pseudorange/pseudorange- |
| | rate update rate |
| Sudden turn | Trigger extra sensing bursts |
| Low dynamics | Longer coherent integration |
| High dynamics | Shorter coherent integration |

Thus, in some embodiments, the predicted motion profile is used to schedule sensing or positioning measurements, including pseudorange, pseudorange-rate, Doppler, angle-of-arrival, angle-of-departure, time-of-arrival, and/or received-signal-strength measurements.

Furthermore, in some embodiments, the motion profile modifies the assumed quality of the observations. The following table describes an example of motion profile predictions and a corresponding estimator adaptation:

| Motion prediction | Estimator adaptation |
|---|---|
| High vibration | Increase measurement noise for angle/ |
| | RSSI-based observations |
| High angular rate | Increase pseudorange-rate uncertainty |
| Stable terminal | Reduce measurement noise covariance |
| Sensor confidence | Deweight IMU-aided prediction |
| low | |
| Suspected | Deweight affected measurements |
| multipath/blockage | |

Thus, in some embodiments, the predicted motion profile is used to adjust measurement-noise covariance, process-noise covariance, sensor weighting, outlier thresholds, and/or integrity-monitoring thresholds in a positioning or sensing estimator.

There are a number of example embodiments described herein.

Example 1 is a communication terminal including an antenna to form and steer one or more communication beams; one or more sensors configured to generate motion-related sensor data associated with motion of the antenna; and a predictive signal processing engine. The predictive signal processing engine is configured to process time-ordered sequences of the motion-related sensor data to generate predicted motion characteristics of the antenna. The communication terminal also includes an acquisition and tracking subsystem coupled to the predictive signal processing engine and configured to control at least one beamforming parameter of the antenna based on the predicted motion characteristics, wherein the acquisition and tracking subsystem adapts the at least one beamforming parameter based on predictions to maintain alignment between the antenna and a remote communication node.

Example 2 is the communication terminal of example 1 that may optionally include that the predictive signal processing engine is a classifier model.

Example 3 is the communication terminal of example 1 that may optionally include that the predictive signal processing engine is a regression model to predict one or more motion statistics.

Example 4 is the communication terminal of example 3 that may optionally include that the regression model is trained using data derived from superposition of constituent motions and captured by inertial sensors that are onboard the antenna.

Example 5 is the communication terminal of example 1 that may optionally include that the predictive signal processing engine comprises an encoder trained by unsupervised learning to generate a low-dimensional motion embedding, and a supervised model trained using the motion embedding and labels.

Example 6 is the communication terminal of example 5 that may optionally include that the unsupervised learning uses auto-encoders to reduce dimensionality of motion data.

Example 7 is the communication terminal of example 1 that may optionally include that the predictive signal processing engine is trained with spectral decomposition of motion-related sensor data.

Example 8 is the communication terminal of example 7 that may optionally include that the spectral decomposition comprises a Fourier Transform.

Example 9 is the communication terminal of example 1 that may optionally include that the predictive signal processing engine is trained using few-shot learning comprising clustering model outputs to generate pseudo-labels and training using the pseudo-labels.

Example 10 is the communication terminal of example 9 that may optionally include that the clustering comprises K-means clustering, hierarchical clustering or spectral clustering.

Example 11 is the communication terminal of example 1 that may optionally include that predictive signal processing engine uses a probabilistic loss function to address non-unique mappings, sensor sequences and motion labels.

Example 12 is the communication terminal of example 11 that may optionally include that the predictive signal processing engine is configured to output parameters of a mixture distribution.

Example 13 is the communication terminal of example 1 that may optionally include that inferences made on a pretrained data-driven model are utilized to adapt one or more parameters of one or more model-based acquisition and tracking functions.

Example 14 is the communication terminal of example 1 that may optionally include that the acquisition and tracking subsystem is configured to control the at least one beamforming parameter by adjusting a beamwidth of the antenna based on vibration statistics.

Example 15 is the communication terminal of example 1 that may optionally include that the acquisition and tracking subsystem is configured to control the at least one beamforming parameter comprises adjusting a beam stride or dithering stride of a tracking operation based on a predicted motion profile.

Example 16 is the communication terminal of example 1 that may optionally include that the acquisition and tracking subsystem is configured to control the at least one beamforming parameter comprises ramping transmit power to compensate for loss of effective aperture caused by platform tilt or blockage.

Example 17 is the communication terminal of example 1 that may optionally include that the predictive signal processing engine generates the predicted motion characteristics periodically at intervals of one or more seconds.

Example 18 is the communication terminal of example 1 that may optionally include that controlling the at least one beamforming parameter comprises initiating a handover to a different satellite or constellation in response to predicted shadowing.

Example 19 is the communication terminal of example 1 that may optionally include that the antenna comprises a flat-panel antenna having an array of antenna elements.

Example 20 is the communication terminal of example 1 that may optionally include that the array comprises a metasurface antenna aperture having tunable elements configured to control a radiation pattern.

Example 21 is the communication terminal of example 1 that may optionally include that the communication terminal is mounted on a vehicle comprising at least one of an automobile, a maritime vessel, or an aircraft.

Example 22 is a method that performs one or more of the communication terminal of examples 1-21.

Example 23 is a method that includes receiving time-sequenced motion data, including sampling inertial sensors including an accelerometer and a gyroscope over a time period; generating a prediction of at least one motion characteristic, including classifying the time-sequenced motion data into one of a plurality of motion scenarios; determining at least one control adjustment for acquisition and tracking based on the one motion scenario into which the time-sequenced motion data is classified; and controlling acquisition and tracking by adjusting at least one beamforming parameter to modify beam steering.

Example 24 is the method of example 23 that may optionally include that generating the prediction of at least one motion characteristic comprises regressing, with a regression model, one or more vibration statistics including frequency or amplitude.

Example 25 is the method of example 23 that may optionally include that generating the prediction of at least one motion characteristic comprises transforming the motion data using a spectral decomposition prior to inference.

Example 26 is the method of example 23 that may optionally include that generating the prediction of at least one motion characteristic comprises producing a low-dimensional embedding using an encoder trained by unsupervised learning and applying supervised learning using the embedding.

Example 27 is the method of example 23 that may optionally include that generating the prediction of at least one motion characteristic comprises using few-shot learning with clustering-based pseudo-label generation.

Example 28 is the method of example 23 that may optionally include that controlling acquisition and tracking comprises increasing a tracking dithering stride.

Example 29 is the method of example 23 that may optionally include that controlling acquisition and tracking comprises changing beamwidth based on predicted vibration characteristics.

Example 30 is the method of example 23 that may optionally include training, by a communication terminal, a motion characteristic model using augmented data for platform classification, including at least one of a boat type, vehicle type, and platform type, and wherein the motion characteristic model is operable to classify parameters (e.g., height, weight, center of mass, vehicle dynamic limitations, suspension, etc.). The method further comprising using the model to constrain probabilistic conditions for acquisition and tracking.

Example 31 is a communication terminal that performs one or more of the operations of examples 23-30.

Example 32 is a satellite terminal that includes an antenna; an acquisition and tracking (A&T) subsystem coupled to the antenna to establish and maintain communications with one or more satellites based on motion profile information corresponding to motion of the antenna; and a predictive signal processing engine to predict characteristics of motion profile of one or more satellite communication antennas using sequence of input sensory measurements including but not limited to inertial sensory measurements. The predictive signal processing engine uses a generative model to synthesize motion data in a plurality of stages, where the plurality of stages comprises: a first stage to train an unsupervised model using limited real data to train an unsupervised model to learn a feature space, and a second stage operable to use a decoder part of the unsupervised model to synthetically generate sensory data that executes motion.

Example 33 is a satellite terminal comprising: an antenna; an acquisition and tracking (P&T) subsystem coupled to the antenna to establish and maintain communications with one or more satellites based on motion profile information corresponding to motion of the antenna; and a predictive signal processing engine to predict characteristics of motion profile of one or more satellite communication antennas using sequence of input sensory measurements including but not limited to inertial sensory measurements, wherein the predictive signal processing engine includes a model that is trained to learn motion clues from unlabeled traces of sensory inertial data collected by one or more inertial sensors of the one or more satellite communication antennas.

Example 34 is the communication terminal of example 33 that may optionally include that as part of training the model, an autoencoder is trained on a transformation of sequential input sensory motion data.

Example 35 is the communication terminal of example 34 that may optionally include that training of the model includes utilizing spectral decomposition such as Fourier Transform (FT) as part of the transformation.

Example 36 is the communication terminal of example 34 that may optionally include that during an inference step, different parts of the spectrum of data are masked (filtered) and presented to the model after training to enforce an unsupervised deep model to reconstruct the manipulated data based on learnt features.

Example 37 is a communication system comprising: a training computing environment training a motion-prediction model using motion data collected under known motion conditions; and a communication terminal executing the trained model to predict motion characteristics and control acquisition and tracking based on the predictions.

Example 38 is the communication terminal of example 37 that may optionally include that the motion data is collected by executing motion using a robot manipulator, hexapod, or vehicle platform.

Example 39 is the communication terminal of example 37 that may optionally include that training includes augmenting data using controlled indoor or outdoor test captures.

Example 40 is the communication terminal of example 37 that may optionally include that training includes generating synthetic motion data using a generative model trained on real-world motion data.

Example 41 is the communication terminal of example 37 that may optionally include that the generative model comprises a variational autoencoder or a generative adversarial network.

Example 42 is the communication terminal of example 32 and may optionally include training with augmented data for platform classification (Boat type details, Vehicle type details, Platform type details, etc.), which are used to constrain the probabilistic conditions of Acquisition & Tracking (A&T). Many details can be classified, including but not limited to (height, weight, center of mass, vehicle dynamic limitations, suspension, etc.), thereby enhancing satellite communication accuracy and robustness by tailoring acquisition and tracking to the platform's specific characteristics.

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

1. A communication terminal comprising:
an antenna to form and steer one or more communication beams;
one or more sensors configured to generate motion-related sensor data associated with motion of the antenna;
a predictive signal processing engine configured to process time-ordered sequences of the motion-related sensor data to generate predicted motion characteristics of the antenna; and
an acquisition and tracking subsystem coupled to the predictive signal processing engine and configured to control at least one beamforming parameter of the antenna based on the predicted motion characteristics, wherein the acquisition and tracking subsystem adapts the at least one beamforming parameter based on predictions to maintain alignment between the antenna and a remote communication node.

2. The communication terminal of claim 1 wherein the predictive signal processing engine is a classifier model.

3. The communication terminal of claim 1 wherein the predictive signal processing engine is a regression model to predict one or more motion statistics.

4. The communication terminal of claim 3 wherein the regression model is trained using data derived from superposition of constituent motions and captured by inertial sensors that are onboard the antenna.

5. The communication terminal of claim 1 wherein the predictive signal processing engine comprises an encoder trained by unsupervised learning to generate a low-dimensional motion embedding, and a supervised model trained using the motion embedding and labels.

6. The communication terminal of claim 5 wherein the unsupervised learning uses auto-encoders to reduce dimensionality of motion data.

7. The communication terminal of claim 1 wherein the predictive signal processing engine is trained with spectral decomposition of motion-related sensor data.

8. The communication terminal of claim 7, wherein the spectral decomposition comprises a Fourier Transform.

9. The communication terminal of claim 1 wherein the predictive signal processing engine is trained using few-shot learning comprising clustering model outputs to generate pseudo-labels and training using the pseudo-labels.

10. The communication terminal of claim 9, wherein the clustering comprises K-means clustering, hierarchical clustering or spectral clustering.

11. The communication terminal of claim 1 wherein the predictive signal processing engine uses a probabilistic loss function to address non-unique mappings, sensor sequences and motion labels.

12. The communication terminal of claim 11 wherein the predictive signal processing engine is configured to output parameters of a mixture distribution.

13. The communication terminal of claim 1 wherein inferences made on a pretrained data-driven model are utilized to adapt one or more parameters of one or more model-based acquisition and tracking functions.

14. The communication terminal of claim 1, wherein the acquisition and tracking subsystem is configured to control the at least one beamforming parameter by adjusting a beamwidth of the antenna based on vibration statistics.

15. The communication terminal of claim 1, wherein the acquisition and tracking subsystem is configured to control the at least one beamforming parameter comprises adjusting a beam stride or dithering stride of a tracking operation based on a predicted motion profile.

16. The communication terminal of claim 1, wherein the acquisition and tracking subsystem is configured to control the at least one beamforming parameter comprises ramping transmit power to compensate for loss of effective aperture caused by platform tilt or blockage.

17. The communication terminal of claim 1, wherein the predictive signal processing engine generates the predicted motion characteristics periodically at intervals of one or more seconds.

18. A method comprising:
receiving time-sequenced motion data, including sampling inertial sensors including an accelerometer and a gyroscope over a time period;
generating a prediction of at least one motion characteristic, including classifying the time-sequenced motion data into one of a plurality of motion scenarios;
determining at least one control adjustment for acquisition and tracking based on the one motion scenario into which the time-sequenced motion data is classified; and
controlling acquisition and tracking by adjusting at least one beamforming parameter to modify beam steering.

19. The method of claim 18, wherein generating the prediction of at least one motion characteristic comprises regressing, with a regression model, one or more vibration statistics including frequency or amplitude.

20. The method of claim 18, wherein generating the prediction of at least one motion characteristic comprises transforming the motion data using a spectral decomposition prior to inference.

21. The method of claim 18, wherein generating the prediction of at least one motion characteristic comprises producing a low-dimensional embedding using an encoder trained by unsupervised learning and applying supervised learning using the low-dimensional embedding.

22. The method of claim 18, wherein generating the prediction of at least one motion characteristic comprises using few-shot learning with clustering-based pseudo-label generation.

23. The method of claim 18, wherein controlling acquisition and tracking comprises increasing a tracking dithering stride.

24. The method of claim 18, wherein controlling acquisition and tracking comprises changing beamwidth based on predicted vibration characteristics.

25. The method of claim 18, further comprising:
training, by a communication terminal, a motion characteristic model using augmented data for platform classification, including at least one of a boat type, vehicle type, and platform type, and wherein the motion characteristic model is operable to classify parameters including at least one of height, weight, center of mass, vehicle dynamic limitations, or suspension; and
wherein controlling acquisition and tracking includes constraining probabilistic conditions for acquisition and tracking.

26. A satellite terminal comprising:
an antenna;
an acquisition and tracking (A&T) subsystem coupled to the antenna to establish and maintain communications with one or more satellites based on motion profile information corresponding to motion of the antenna; and
a predictive signal processing engine to predict characteristics of motion profile of one or more satellite communication antennas using sequence of input sensory measurements including but not limited to inertial sensory measurements, wherein the predictive signal processing engine uses a generative model to synthesize motion data in a plurality of stages, wherein the plurality of stages comprises:
a first stage to train an unsupervised model using limited real data to train an unsupervised model to learn a feature space, and
a second stage operable to use a decoder part of the unsupervised model to synthetically generate sensory data that executes motion.
